(19) United States
(12) Patent Application Publication
(10) Pub. No.: US 2025/0380723 A1
(43) Pub. Date: Dec. 18, 2025

(54) IMPROVEMENTS IN OR RELATING TO ORGANIC COMPOUNDS

(71) Applicant: GIVAUDAN SA, VERNIER (CH)

(72) Inventors: Raja CHOUKET, Avignon (FR); Kerry WARD-ROTHERHAM, Swadlincote, Derbyshire (GB); Bryan AVILES, Louisville, KY (US); Jennifer JARVIS-CONLEY, Louisville, KY (US); Kelly POLTE, Louisville, KY (US)

(21) Appl. No.: 18/874,787

(22) PCT Filed: Jun. 15, 2023
(86) PCT No.: PCT/EP2023/066065

§ 371 Date: Dec. 13, 2024

Related U.S. Application Data
(60) Provisional application No. 63/429,010, filed on Nov. 30, 2022.

(30) Foreign Application Priority Data
Jul. 1, 2022 (EP) 22182627.4

(51) Int. Cl. A23L 5/43; A23L 5/49; A23L 13/40

(52) U.S. Cl. CPC A23L 5/43; A23L 5/49; A23L 13/43

(57) ABSTRACT

The present invention is related a colourant composition that when incorporated into food and beverage products is both shelf-life stable and delivers a desirable colour transition on demand in response to a stimulus, such as heating. Said colour composition is based on an innovative combination of pigments and an encapsulated alkali material, acid material, metallic cation and/or salt.

### FIELD OF THE INVENTION

The present invention is concerned with methods and compositions for effecting a colour change in a processed food or beverage product in response to a stimulus, such as the application of heat to the product. More particularly, the invention is concerned with methods and compositions of effecting colour change in a meat analogue product during the process of cooking said product. The invention is also concerned with processed foods or beverages, and more particularly meat analogue products, containing said compositions.

### BACKGROUND OF THE INVENTION

Colour plays a crucial role in the perception of food and beverages. Along with flavour and texture, colour is considered to be a major driver in the perception of quality of food and beverages. The relationship between colour and consumer perception of quality does not stop at the initial colour of a food or beverage. Colour transitions that occur in foods and beverages as they are processed also play an important role in the perception of quality. Colour change in a food or beverage during storage is a cause of concern for consumers, but colour change during processing (e.g. cooking) is entirely expected, and indeed desirable, provided the extent and rate of colour change is appropriate. So, consumers are usually concerned with predictable colour change, such as the colour change of a piece of meat from red-pink to grey-brown during cooking. But occasionally, colour change can be designed to create striking and surprising aesthetic colour effects, for example when mixing cocktails or stirring children's drinks or confectionary products.

Controlling colour change, both its extent and its rate, is particularly important in meat analogue products. Diets based on a reduced consumption of meat are increasingly popular with consumers as they seek to balance personal health and well-being with a concern for the environmental impact of intensive farming practices. Meat analogue products, such as plant-based meats, lab-grown meat and hybrid products containing mixtures of the foregoing, are increasing in prominence in the public consciousness. In turn, this has created mounting pressure on the processed food industry to create attractive meat-analogue products that behave like real meat in terms of taste, texture and appearance, both in storage and during cooking. Mimicking the characteristics of meat during the cooking process is a particularly challenging problem. One of those characteristics is the colour transition of meat products from a reddish or pink appearance when raw, to brownish or brown-gray upon cooking. The preservation of the pinkish-red appearance of raw meat during the shelf-life of the products is another important characteristic that must be delivered.

In order to impart the red or pink colour to an uncooked meat analogue product, it is common to employ additive pigments. This is necessary because plant-based proteins, which are major constituents in many meat-analogue products, are typically white to yellow or light brown to tan in colour. Examples of pigments that are presently added to such products include, but are not limited to astaxanthin, powders or juices from red beets, paprika, turmeric, or fruit- or vegetable-derived colourants obtained from strawberries, red raspberries, red cabbage or the like.

Problematically, some of these colourants, such as astaxanthin or beet-derived materials, are relatively heat stable. By way of illustration, when beet-derived colourants are added to meat analogue burgers, the inside of the burgers can remain pink or orange-coloured even after cooking to 165° F. (74° C.) in a pan for several minutes. Some consumers interpret this lack of colour change as a sign that the product is not fully cooked and so continue cooking the product for longer duration or to higher temperatures than desired in order to deliver the product in optimal condition for consumption. Accordingly, the judicious selection of pigments is required in order that the desired colour transition is created throughout the entire mass of the product, in a reasonable time period at the required cooking temperature.

On the other hand, some pigments are relatively unstable, and can cause an undesirable colour transition in meat-analogue products during storage at room temperature or even at refrigeration temperatures.

Selecting pigments that exhibit the required stability during storage, but which rapidly and extensively change colour throughout a product during cooking is not a straightforward task, and the palette of available natural ingredients is severely limited as a result. GMO colourants are known, and an example of a heme-containing protein colourant is described in U.S. Pat. No. 9,808,029. The materials are prepared from genetically-modified yeast cells on an industrial scale. However, consumers remain skeptical and may reject them for ethical, religious and other reasons related to health & well-being.

There remains a need to address the deficiencies in the prior art and expand the palette of useful pigment materials that can add colour to processed foods and beverages, and which are both shelf-life stable and deliver a desirable colour transition on demand and in response to a stimulus, such as heat during a cooking process.

### SUMMARY OF THE INVENTION

The applicant has discovered in a surprising manner, a colourant composition that when incorporated into food and beverage products is both shelf-life stable and delivers a desirable colour transition on demand in response to a stimulus, such as heating. Said colour composition is based on an innovative combination of pigments and an encapsulated alkali material, acid material, metallic cation and/or salt.

Accordingly, the invention provides in a first aspect a colourant composition comprising a pigment and alkali material, acid material, metallic cation and/or salt, wherein the alkali material, acid material, metallic cation and/or salt is encapsulated in an encapsulating medium.

In a second aspect, the invention provides a food or beverage product comprising the colourant composition and an edible substrate.

In a third aspect, the invention provides a method of incorporating the colourant composition into an edible substrate to provide a food or beverage product, the method comprising the steps of simultaneous, separate or sequential addition of a pigment and an encapsulated alkali material to the edible substrate.

In a fourth aspect, the invention provides a method of effecting a colour change in a food or beverage product, the method comprising the step of a) simultaneously, separately or sequentially adding a pigment as defined herein and an encapsulated alkali material, acid material, metallic cation and/or salt to the edible base, and b) submitting the food or beverage obtained in step a) to an energetic process, such as application of heat and/or mechanical energy to release the alkali material, acid material, metallic cation and/or salt.

In a fifth aspect, the invention provides the use of an encapsulated alkali material, acid material, metallic cation and/or salt to affect a colour change in a food or beverage product, the product comprising a colourant composition as defined herein, wherein the colour change is affected when the product is subjected to a stimulus, such as heat and/or mechanical energy.

The details, examples and preferences provided in relation to any one or more of the stated aspects or embodiments of the present invention will be further described herein and apply equally to all aspects and embodiments of the present invention. Any combination of embodiments, examples and preferences described herein below in all possible variations thereof are encompassed by the present invention unless otherwise indicated herein, or otherwise clearly contradicted by context.

### BRIEF DESCRIPTION OF THE DRAWINGS

FIG. 1. Impact of pH increase on colour transformation of phycoerythrin-containing patties during cooking.

FIG. 2. 2A Impact of pH increase on initial colour during shelf life (chilled storage) of phycoerythrin-containing patties. 2B shows that there is no colour shift of the of phycoerythrin-containing patties at chilled storage conditions when the alkali material is encapsulated.

FIG. 3. Impact of alkali material on the colour transformation of betanin and anthocyanin-containing patties during cooking.

FIG. 4. Impact of acid on colour transformation of Santalin-containing patties during cooking.

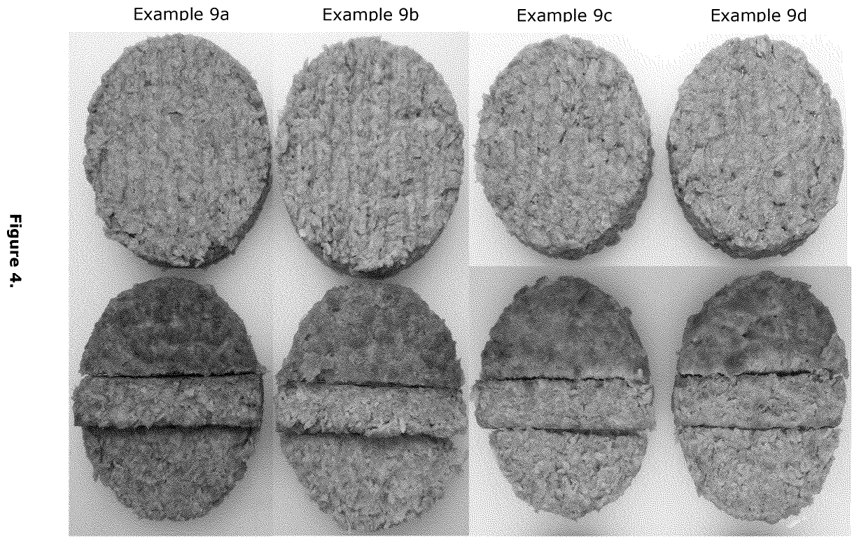

FIG. 5. Impact of alkali on colour transformation of beet/anthocyanin/malt blend patties during cooking.

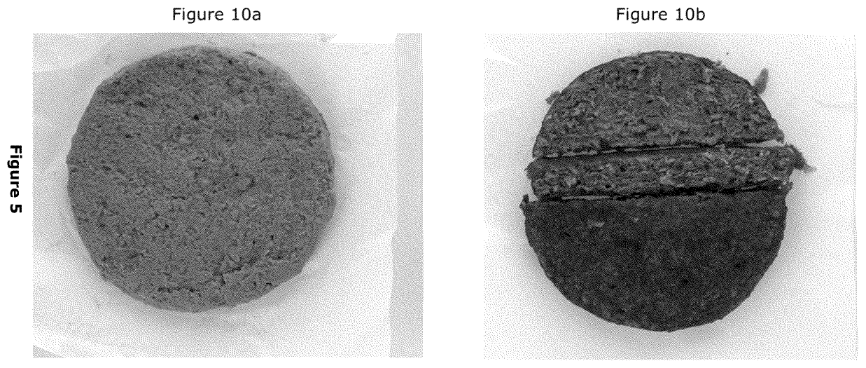

FIG. 6. Impact of alkali on colour transformation of beet/anthocyanin/cooked apple juice blend patties during cooking.

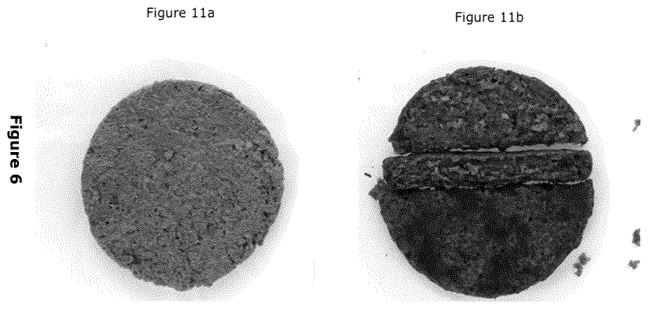

### DETAILED DESCRIPTION OF THE INVENTION

The present invention is based on the use of a pH trigger to initiate and/or accelerate a desirable colour change of pigments, such as phycoerythrins, betanins and anthocyanins. The trigger is actuated by an energetic stimulus, such as the application of heat or mechanical energy to encapsulation media encapsulating an alkali material, and acid material, or a material that is a metallic cation and/or a metallic salt, or a mixture thereof, releasing said material into contact with the pigment, whereupon the pigment is degraded or altered, changing its chromatic properties. A colour composition as herein defined suitable for use in processed food or beverage products that comprises both a pigment and a material that can alter the colour of the pigment, and wherein the pigment and material are spatially separated by an encapsulating medium until acted upon by an appropriate energetic stimulus is believed by the applicant to be novel.

For the sake of brevity, the invention will be further described with reference to embodiments in which the composition contains an encapsulated alkali, and the trigger for colour change is a pH trigger. However, as stated herein, other encapsulated materials and triggers are contemplated by the present invention.

Furthermore, when the colourant composition is incorporated in a food or beverage product, the colour change is substantially uniformly distributed throughout the entire product. Still further, the action of alkali material, acid material, metallic cation and/or salt on the pigment accelerates the colour change, such that in meat analogue products, the rate of colour change during cooking of the product mimics that of real meat. Because the colour change is substantial, uniformly extensive and rapid, consumers receive a confirmatory visual cue that prevents over-cooking or cooking at too high temperatures. In a particular example of a plant-based meat patty containing a colourant composition of the present invention, after only a few minutes of cooking at a frying temperature of about 165 degrees fahrenheit, the colour change can be observed through to the centre of the patty and over-cooking can be avoided.

Another advantage of this novel approach resides in the fact that because the alkali material, acid material, metallic cation and/or salt is encapsulated, products resist colour change during prolonged periods under conditions of storage.

The term “colour” refers to the colour properties such as hue, chroma, purity, saturation, intensity, vividness, value, lightness, brightness and darkness, and colour model system parameters used to describe these properties, such as Commission Internationale de l'Eclairage CIE 1976 CIELAB colour space L*a*b* values.

The term “hue” refers to the colour property that gives a colour its name, for example, red, blue and brown.

The terms “comprises,” “comprising,” “has,” “having,” “includes,” “including,” “contains,” “containing,” or any other variation are open-ended and are intended to cover a non-exclusive inclusion of elements, such that an article, apparatus, compound, composition, combination, method, or process that “comprises,” “has,” or “includes,” or “contains” a recited list of elements does not include only those elements but may include other elements not expressly listed, recited or written in the specification or claims. An element or feature proceeded by the language “comprises . . . a,” “contains . . . a,” “has . . . a,” or “includes . . . a” does not, without more constraints, preclude the existence or inclusion of additional elements or features in the article, apparatus, compound, composition, combination, method, or process that comprises, contains, has, or includes the element or feature.

The terms “a” and “an” are defined as one or more unless expressly stated otherwise or constrained by other language herein. An element or feature proceeded by “a” or “an” may be interpreted as one of the recited element or feature, or more than one of the element or feature. For instance, a pigment CGA may be interpreted as one pigment or as more than one pigments

The terms “about,” “approximately,” “essentially,” “substantially,” any other version thereof, or any other similar relative term, or similar term of approximation, are defined as being close to as understood by one having ordinary skill in the art. By way of non-limiting, illustrative embodiments, these terms are defined to be within 20% of a recited value, or defined to be within 10% of a recited value, or defined to be within 5% of a recited value, or defined to be within 4% of a recited value, or defined to be within 3% of a recited value, or defined to be within 2% of a recited value, or defined to be within 1% of a recited value, or defined to be within 0.5% of a recited value, or defined to be within 0.25% of a recited value, or defined to be within 0.1% of a recited value.

It should be understood that when an amount in weight percent is described in the present disclosure, it is intended that any and every amount within the range, including the end points, is to be considered as having been expressly disclosed. For example, the disclosure of “a range of from about 1 to about 10” is to be read as indicating each and every possible number along the continuum between about 1 and about 10. It is to be understood that the inventors appreciate and understand that any and all data points within the range are to be considered to have been specified, and that the inventors have possession of the entire range and all points within the range.

With regard to the first aspect of the invention, the colourant composition comprises a pigment (one or more pigments) and an alkali material, acid material, metallic cation and/or salt encapsulated in a suitable encapsulating medium.

As used herein, the term “pigment” refers to any substance that imparts colour by absorbing or scattering light at different wavelengths.

The pigment or pigments used in the present invention may be sensitive to pH and/or sensitive to temperature (thermally sensitive).

As “pH sensitive” pigment is understood in the present invention as a pigment that undergoes a colour change (for example measured using the CIELAB or by UV-Vis absorption using spectrophotometer) when is exposed to a change of pH. The colour change may be a change in colour retention or a spectral shift. In certain embodiments, the colour change is of at least 2%, at least 5%, at least 6%, at least 7%, 8%, 9%, 10%, 11%, 12%, 13%, 14%, 15%, 16%, 17%, 18%, 19%, 20%, 22%, 24%, 26%, 28%, 30%, or at least 40% change. Examples of pH sensitive pigments include, without limitation, anthocyanin (which change of colour) Carmin (that precipitate at acidic pH), phycocyanin or santalin (degrade and precipitate at acidic pH), etc.

As “thermally sensitive” pigment is understood in the present invention as a pigment that undergoes a colour change (for example measured using the CIELAB or by UV-Vis absorption using spectrophotometer) when is exposed to a change of temperature. The colour change may be a change in colour retention or a spectral shift. In certain embodiments, the colour change is of at least 2%, at least 5%, at least 6%, at least 7%, 8%, 9%, 10%, 11%, 12%, 13%, 14%, 15%, 16%, 17%, 18%, 19%, 20%, 22%, 24%, 26%, 28%, 30%, or at least 40% change. Generally, thermally sensitive pigments undergo a colour change when the pigment is expose to high temperatures. Examples of thermally sensitive pigments include, without limitation, betanin and its derivatives such as betaxanthin, phycobilins such as phycocyanin, etc

In certain embodiments, the pigments are only sensitive to pH or only sensitive to a temperature change.

The inventors of the present invention have surprisingly observed that the degradation and colour change of certain pigments like phycoerythrin pigments is enhanced when the pigment is submitted to high temperatures in basic conditions. The example 1 of the present application demonstrated that increasing pH accelerates the thermal degradation of the phycoerythrin and thus the colour change is faster and more efficient.

In certain embodiments, the pigments are pH and thermally sensitive.

Certain pigments may be sensitive to other conditions. For example, the degradation of betalain derived from beetroot is accelerated in the presence of FE2+/FE3+, AL3+. Also, the degradation of other natural pigments may be accelerated using high ionic strength (high content of salt in medium).

Therefore, in certain embodiments, the pigment is sensitive to increase of ionic strength or presence of metallic cations (such as FE2+/FE3+, AL3+ etc). The use of metallic cations and/or salts may be used in the present invention to increase the sensitivity of pigments to other conditions such as pH changes and/or temperature changes.

As already mentioned, the pigments may be sensitive to one or more of the conditions described herein. For example, the pigment may be sensitive to pH only, to temperature only or to ionic strength increase. In certain embodiments, the pigment is sensitive to more than one condition, such as pH and temperature, or temperature and ionic strength, etc.

Pigments useful in the present invention include those obtained from natural sources, such as plants, fungi, bacteria, algae or animal sources. They may be native, i.e. extracted unmodified from their natural state, or taken from their natural state and purified or even chemically modified. Also, pigments obtained from fermentation may be used in the present invention.

In certain embodiments, the pigment is selected from the group consisting of phycoerythrobilins (such as phycoerythrin), anthocyanins (such as pelargonidin, cyanidin and peonidin-based anthocyanins) betalains (such as betacyanins, betaxanthins), caramels, caramelized fruit and vegetables juices, burnt sugars, caramel colors, carotenoids, malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, santalin, santalin complexed with metal or mixtures thereof.

Is understood that one or more pigments can be used together in the present invention.

In certain embodiments, the pigments may be selected for their ability to create a red-pink colour in a food product that is reminiscent of a meat in its raw state. However, the pigments useful in colourant compositions according to the present invention are thermally labile, and their characteristic red-pink colour fades when heated.

In particular embodiments of the invention the composition may comprise a phycoerythrobilin pigment. Useful phycoerythrobilin pigments include those more fully described in WO2022043059, which pigments are incorporated herein by reference.

Particularly useful examples of the phycoerythrobilin pigments are phycoerythrins.

Phycoerythrins are mainly produced in Cyanophyceae, Cryptophyceae and red algae such as Porphyra tenera and microalgae such as Pseudanabaena sp, Pseudanabaena sp., Anabaena circinalis, Pseudanabaena sp., Porphyridium purpureum, Porphyridium cruentum and Anabaena circinalis. The phycoerythrins can be classified into four classes: R-phycoerythrin (R-PE), B-phycoerythrin (B-PE), C-phycoerythrin (C-PE) and B-phycoerythrin (B-PE), based on their origin and absorption spectrum. Spectral differences between phycoerythrins are due to the presence of different types of bilin prosthetic groups. R-PE is the most abundant phycobiliprotein from red algae, cryptophytes and marine unicellular cyanobacteria. The PE chromophore is composed of three polypeptide subunits, alpha subunit complex (18-20 kDa), beta subunit (19.5-21 kDa) and gamma subunit (30 kDa), and is shown below:

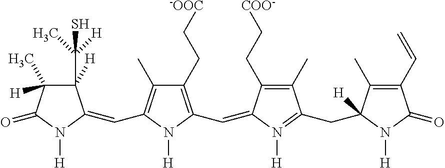

In particular embodiments, the Phycoerythrins are pH and/or temperature sensitive.

In particular embodiments of the invention the colour composition may comprise an anthocyanin pigment. In certain embodiments of the invention the colour composition may comprise at least 0.001% of an anthocyanin pigment. In certain embodiments of the invention the colour composition may comprise from 0.001% w/w to 95% w/w of an anthocyanin pigment, such as from about 0.01% w/w to about 80% w/w, such as from 0.01% w/w, 0.02% w/w, 0.03% w/w, 0.04% w/w, 0.05% w/w, 0.06% w/w, 0.0.7% w/w, 0.08% w/w, 0.09% w/w. 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w to 95%, 90%, 80%, 70%, 60%, 50%, 40%, 30%, 20%, 15% w/w of an anthocyanin pigment. In certain embodiments, the colour composition may comprise from 0.01% w/w to 5% w/w of an anthocyanin pigment.

Anthocyanins are glycosides of the sugar-free anthocyanidins (the aglycone). The sugar molecules in anthocyanins are bound via O-glycosidic bonds to one or more of the hydroxy groups typically present in an anthocyanidin molecule. Most naturally occurring anthocyanins are 3-O-glycosides.

The most common types of anthocyanidins present in plants are cyanidin, delphinidin, pelargonidin, peonidin, petunidin and malvidin, in which hydroxy groups in the 3, 5, 7 and at least one of the 3′, 4′ or 5′ positions are sugar-substituted. Examples of natural anthocyanins that may be used in the colourant composition include, but are not limited to pelargonidin, cyanidin and peonidin-based anthocyanins.

Examples of sugar molecules found in anthocyanin structures include arabinose, galactose, glucose, rhamnose, rutinose, sambubiose, sophorose and xylose. An anthocyanin can be substituted with hydrogen, hydroxyl, and/or methoxyl groups at various positions. Anthocyanins can also be acylated, where they can have one or more molecules esterified to the sugar molecules at the 2-, 3-, 4- and/or 6-position of a monosaccharide.

Many anthocyanins are acylated (generally at the C6-OH group of a glucose moiety), with either aliphatic acids (e.g., acetic, malic, malonic, oxalic, or succinic acid) or phenolic acids (e.g., p-hydroxybenzoic, caffeic, p-coumaric, ferulic, or sinapic acid). Thus, the anthocyanins may be in the form of an acylated glycoside anthocyanin. For example, and without limitation, pelargonidin-based acylated anthocyanins, cyanidin-based acylated anthocyanins and peonidin-based acylated anthocyanins or structural analogues of pelargonidin-based acylated anthocyanins, cyanidin-based acylated anthocyanins and peonidin-based acylated anthocyanins.

Anthocyanin pigments may be present as an extract obtained or obtainable from a plant from the Brassicaceae, the Rosaceae, the Solanaceae, the Convolvulaceae, the Apiaceae family, the Poaceae family, Hylocereus, the Opuntia or mixtures thereof. The term mixture refers to a mixture obtained or obtainable either when the plant, or the part of the plant containing the anthocyanins, from the Brassicaceae, the Rosaceae, the Solanaceae, the Poaceae and/or the Apiaceae family are extracted together using a single solvent or when the plant or the part of the plant containing the anthocyanins, from the Brassicaceae, the Rosaceae, the Solanaceae, the Poaceae and/or the Apiaceae family are extracted independently and the resulting extracts combined. The plant of the Brassicaceae family may be Raphanus sativus L. (red radish). The plant of the Rosaceae family may be the Fragaria (strawberry). The plant of the Solanaceae family may be the Solanum tuberosum (red potato). The plant of the Convolvulaceae family may be Ipomoea batatas (purple sweet potato root). The plant of the Apiaceae family may be Daucus carota ssp. sativus var. atrorubens Alef. (black carrot). The plant of the Poaceae family may be Zea mays (corn). Anthocyanins from Grape, Berries and hibiscus can also be used in the present invention.

Red radishes (Raphanus sativus L.) and red-fleshed potatoes (Solanum tuberosum L.) provide colour characteristics similar to FD&C Red #40. According to embodiments, the anthocyanin is a red radish derived colour.

According to embodiments, the anthocyanin is a red or purple corn derived colour.

The major pigments of red radish and red-fleshed potatoes have been identified as pelargonidin-3-sophoroside-5-glucoside acylated with malonic acid and either p-coumaric and/or ferulic acids and pelargonidin-3-rutinoside-5-glucoside acylated with p-coumaric acid, respectively (Rodríguez-Saona, L. E. et al, J. Food Sci. 1999, 64, 451-456, the disclosure of which is herein incorporated by reference). According to certain embodiments, the anthocyanins used in the colourant composition may comprise pelargonidin-3-sophoroside-5-glucoside acylated with malonic acid and either p-coumaric and/or ferulic acids, and/or pelargonidin-3-rutinoside-5-glucoside acylated with p-coumaric acid.

According to certain illustrative embodiments, the anthocyanin is a black carrot derived colour.

Recently, cyanidin 3-xylosyl(glucosyl)galactosides acylated with sinapic acid, ferulic acid, and coumaric acid were identified as the major anthocyanins in black carrot (Cuevas Montilla, E., et al, J. Agric. Food Chem. 2011, 59, 3385-3390, the disclosure of which is herein incorporated by reference). According to certain embodiments, the anthocyanins used in the colourant composition comprises cyanidin 3-xylosyl(glucosyl)galactosides acylated with sinapic acid, ferulic acid, and coumaric acid.

In particular embodiments, the anthocyanin is pH and/or temperature sensitive.

In particular embodiments of the present invention the colourant composition may comprise betalain pigments.

Betalains are a class of red and yellow tyrosine-derived pigments found in plants of the order Caryophyllales. There are two categories of betalains: the first is the betacyanins, which appear reddish to violet in colour, and examples of which include betanin, isobetanin, probetanin, and neobetanin; and the second is the betaxanthins, which appear yellow to orange, and examples of which include vulgaxanthin, miraxanthin, portulaxanthin, and indicaxanthin.

In certain embodiments of the invention the colour composition may comprise at least 0.001% of a Betalain pigment. In certain embodiments of the invention the colour composition may comprise from 0.001% w/w to 95% w/w of a Betalain pigment, such as from about 0.01% w/w to about 80% w/w, such as from 0.01% w/w, 0.02% w/w, 0.03% w/w, 0.04% w/w, 0.05% w/w, 0.06% w/w, 0.07% w/w, 0.08% w/w, 0.09% w/w. 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w to 95%, 90%, 80%, 70%, 60%, 50%, 40%, 30%, 20%, 15% w/w of a Betalain pigment. In certain embodiments, one or more betalain pigments are used. In certain embodiments, the colour composition may comprise from 0.01% w/w to 5% w/w of a betalain pigment.

Betalains particularly useful in the present invention include betacyanins, such as betanin, isobetanin, probetanin, and neobetanin; and/or betaxanthins, such as vulgaxanthin, miraxanthin, portulaxanthin, and indicaxanthin.

Betalains are glycosides of a betanidin aglycone, the core structure of which is betalamic acid (i.e. 4-(2-oxoethylidene)-1,2,3,4-tetrahydropyridine-2,6-dicarboxylic acid).

Betanin is usually obtained from the extract of the juice of Beta vulgaris (e.g. red beets, such as beetroot).

According to particular embodiments of the inventions, betalains may be present as extracts obtained or obtainable from a plant from the Amaranthaceae family. Optionally, the plant from the Amaranthaceae family may be Beta vulgaris (beet). According to particular embodiments of the inventions, betalains may be present as extracts obtained or obtainable from a plant from the Hylocereus family. Optionally, the plant from the Hylocereus family may be Dragon fruit. According to particular embodiments of the inventions, betalains may be present as extracts obtained or obtainable from a plant from the Opuntia family. Optionally, the plant from the Opuntia family may be cactus pear.

In one embodiment, the betalain is a beetroot derived colour. Optionally, the betalain used in the present invention may be betanin.

In particular embodiments, the betalains, such as a betanin is pH and/or temperature sensitive.

In particular embodiments of the present invention the colourant composition may comprise santalin pigments and/or santalin complexed with metal.

Other colourants providing blue or green colours may also be used, including but not limited to phycocyanin, butterfly pea anthocyanin, chlorophyll.

Other colourants providing brown colours and other shades may also be used including but not limited to caramels, caramelized fruit and vegetables juices, burnt sugars, caramel colors, carotenoids, malt, sorghum, fruit juice extracts, iron oxide colors, santalin, santalin complexed with metal etc.

In certain embodiments of the invention the colour composition may comprise at least 0.001% of a phycocyanin, butterfly pea anthocyanin and/or chlorophyll pigment. In certain embodiments of the invention the colour composition may comprise from 0.001% w/w to 95% w/w of a phycocyanin, butterfly pea anthocyanin and/or chlorophyll pigment, such as from about 0.01% w/w to about 80% w/w, such as from 0.01% w/w, 0.02% w/w, 0.03% w/w, 0.04% w/w, 0.05% w/w, 0.06% w/w, 0.0.7% w/w, 0.08% w/w, 0.09% w/w. 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w to 95%, 90%, 80%, 70%, 60%, 50%, 40%, 30%, 20%, 15% w/w of a phycocyanin, butterfly pea anthocyanin and/or chlorophyll pigment. In certain embodiments, the colour composition may comprise from 0.01% w/w to 5% w/w of a phycocyanin, butterfly pea anthocyanin and/or chlorophyll pigment.

In certain embodiments of the invention the colour composition may comprise at least 0.001% of a malt and/or caramel color. In certain embodiments of the invention the colour composition may comprise from 0.001% w/w to 95% w/w of malt and/or caramel color, such as from about 0.01% w/w to about 80% w/w, such as from 0.01% w/w, 0.02% w/w, 0.03% w/w, 0.04% w/w, 0.05% w/w, 0.06% w/w, 0.0.7% w/w, 0.08% w/w, 0.09% w/w. 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w to 95%, 90%, 80%, 70%, 60%, 50%, 40%, 30%, 20%, 15% w/w of a malt and/or caramel color. In certain embodiments, the colour composition may comprise from 0.01% w/w to 5% w/w of a malt and/or caramel color.

Depending on the colour and the colour change that is needed in the product in which the colourant composition is to be employed, one or combinations of several pigments may be used. Depending on the pigments that are desired to be used in a composition according to the invention, a corresponding material can be selected for encapsulation. For example, if a pigment is sensitive to an increase in pH, then it will be suitable to encapsulate an alkali material, and so on.

In certain embodiments, the colourant composition according to the present invention comprises an encapsulated alkali material.

The alkali may be any food grade alkali material, including but not limited to Ammonium Aluminum Sulphate, Ammonium Bicarbonate, Ammonium Carbonate, Ammonium Hydroxide, Ammonium Phosphate dibasic, Calcium Acetate, Calcium Carbonate, Calcium Chloride, Calcium Citrate, Calcium Hydroxide, Calcium Gluconate, Calcium Lactate, Calcium Oxide, Calcium Phosphate, dibasic, Calcium Phosphate tribasic, Calcium Sulphate, Magnesium Carbonate, Magnesium Hydroxide, Potassium Carbonate, Potassium Chloride, Potassium Hydroxide, Potassium Lactate, Potassium Phosphate dibasic, Potassium Phosphate tribasic, Sodium Bicarbonate, Sodium Carbonate, Sodium Citrate, Sodium Hydroxide, Sodium Lactate, Sodium Phosphate monobasic, Sodium Phosphate tribasic, Sodium Phosphate dibasic, Sodium Potassium Tartrate. In preferred embodiments, the alkali is food grade. A particularly preferred alkali is sodium bicarbonate.

In certain embodiments of the invention the colour composition may comprise at least 0.001% of alkali material. In certain embodiments of the invention the colour composition may comprise from 0.001% w/w to 95% w/w of alkali material, such as from about 0.01% w/w to about 80% w/w, such as from 0.01% w/w, 0.02% w/w, 0.03% w/w, 0.04% w/w, 0.05% w/w, 0.06% w/w, 0.0.7% w/w, 0.08% w/w, 0.09% w/w. 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w to 95%, 90%, 80%, 70%, 60%, 50%, 40%, 30%, 20%, 15% w/w of alkali material. In certain embodiments, the colour composition may comprise from 10% w/w to 70% w/w of alkali material

In certain embodiments, the colourant composition according to the present invention comprises an encapsulated acid material.

The acid may be any food grade acid material, including but not limited to Acetic Acid, vinegar, Fumaric Acid Lactic Acid, Phosphoric Acid, Malic Acid, Tartaric Acid. A particularly preferred acid is citric acid.

In certain embodiments, the colourant composition according to the present invention comprises encapsulated metal cations.

The metal cation may be any food grade metal cation, including but not limited to aluminium cations (such as Aluminium sulphate, Aluminium sulphates, Aluminium sodium sulphate, Aluminium potassium sulphate, Aluminium ammonium sulphate, Sodium aluminium phosphate acidic, Sodium aluminium silicate, Potassium aluminium silicate, Calcium aluminium silicate, Aluminium silicate (Kaolin), starch Aluminium Octenyl Succinate), iron oxide and hydroxides, iron sulphate, Iron (III) meso-Tartrate, copper sulfate, copper oxide, etc. A particularly preferred metal cation are Ferrous sulfate and aluminium sulfate

As already mentioned before, the material that is going to be encapsulated will be chosen depending on the pigment that is intendent to be used.

Accordingly, in certain embodiments, colour compositions of the present invention may contain multiple populations of encapsulated material, each type of encapsulating medium may contain a different material. Alternatively, or additionally, an encapsulating medium may contain multiple media, such as an alkali material and a salt by way of example.

In accordance with the present invention, the encapsulating medium is formed from substances when exposed to a suitable stimulus, such as heat, or other stimuli, such as mechanical energy, exposure to moisture, or a combination of the foregoing.

In particular embodiments of the invention, the encapsulating medium comprises a fat, a wax, or mixtures thereof. The fat or wax may be any fat or wax that is safe for consumption by humans, that is capable of encapsulating the alkali material, acid material, metallic cation and/or salt and isolating it from the food or beverage matrix and/or pigment in which it may be dispersed, until such time as its release is desirable under the influence of an introduced stimulus, such as heat, moisture or mechanical stress.

In more particular embodiments, the encapsulating wax, fat or mixtures thereof should be capable of releasing the alkali material, acid material, metallic cation and/or salt at or above the melting temperature of the fat or wax encapsulating material.

The encapsulated alkali material, acid material, metallic cation and/or salt can be prepared by any suitable method known in the art. In particular embodiments, however, when the encapsulating medium comprises a fat or wax or mixtures thereof, it can be prepared by a spray congealing process. Spray congealing is an encapsulation process by which the alkali material, acid material, metallic cation and/or salt is dispersed homogeneously in droplets of the encapsulating medium. The spray congealing process includes the steps of feeding the encapsulating medium into an atomization chamber, atomizing the medium in the chamber into droplets, homogenously dispersing the alkali material, acid material, metallic cation and/or salt in the atomized droplets of encapsulating material and solidifying the droplets. Spray congealing is also known as spray chilling, spray cooling or prilling.

Common spray congealing encapsulating media include fats and waxes of various melting points in the range from about room temperature to about 90 degrees centigrade. Without limitation, and only by way of illustration, suitable encapsulating media for the spray congealing process include fatty acids, fatty alcohols, fatty acid esters, hydrogenated oils, hard fats, triglycerides, and waxes.

According to certain illustrative embodiments, and without limitation, suitable hydrogenated oils include coconut oil, hydrogenated palm oil, hydrogenated cotton seed oil, hydrogenated rapeseed oil, hydrogenated canola oil, hydrogenated soybean oil and mixtures thereof.

According to certain illustrative embodiments, and without limitation, suitable waxes include beeswax, candelilla wax, microcrystalline wax, rice bran wax, carnauba wax and mixtures thereof.

According to other illustrative embodiments, the encapsulated alkali material, acid material, metallic cation and/or salt may be formed by granulation techniques known in the art. Granulation techniques include both dry and wet granulation. Wet granulation encompasses a variety of techniques that can be described under the term of fluid-bed drying or fluid-bed granulation. There are various methods of fluid-bed drying known in the art, including so-called “top spray”, “bottom spray”, and “tangential spray” drying.

Fluid-bed drying is the process of fluidizing a powder comprising particulates or particulate aggregates and then either spraying a coating solution or dispersion to build layers or coatings around the particulates or particulate aggregate to build a larger particle in the form of a coated core; or spraying a binder solution or suspension onto a fluidized powder of particulates or particulate aggregates and causing those particulates or particulate aggregates to agglomerate and form particulate aggregates in the form of a composite of particulate aggregates. As soon as the desired particulate aggregates are formed, spraying of a coating material or a binder solution or suspension is terminated. In some embodiments the liquid may be evaporated.

Another technique that can be used in the present invention is melt emulsification. This technique consists in preparing fat particles by heating the fat, then emulsifying it at high temperature in water and then cooling the emulsion down. This can lead to small round particles.

In embodiments of the invention, the encapsulation of the alkali material, acid material, metallic cation and/or salt may be done by directly including the alkali material, acid material, metallic cation and/or salt in fats and waxes of various melting points in the range from about room temperature to about 90 degrees centigrade (“inclusion”).

Without limitation, and only by way of illustration, suitable encapsulating media include fatty acids, fatty alcohols, fatty acid esters, hydrogenated oils, hard fats, triglycerides, and waxes.

According to certain illustrative embodiments, and without limitation, suitable hydrogenated oils include coconut oil, hydrogenated palm oil, hydrogenated cotton seed oil, hydrogenated rapeseed oil, hydrogenated canola oil, hydrogenated soybean oil and mixtures thereof.

By “inclusion” and “including the alkali material, acid material, metallic cation and/or salt in fats and waxes” is understood in the present application as adding the material to a fat or wax without the aids of sophisticated techniques. For example, the material may be directly incorporated in a melted fat and/or wax, then mixed by standard means so as to provide a fat or wax where the material (alkali material, acid material, metallic cation and/or salt) is homogenously distributed in the mass of the fat and/or wax (as exemplified in example 7).

Then, the fat or wax material can be mould in different shapes and forms as required and let solidify again. For example, the fat and/or wax can spread out on parchment and frozen until solid. If needed, the material could then be cut or shredded in the required particle size.

In certain embodiments, the alkali material, acid material, metallic cation and/or salt is encapsulated by one or more of the following techniques: granulation techniques (including both dry and wet granulation), spray congealing, melt emulsification, inclusion.

For example, two encapsulation methods can be use subsequently. For example, the encapsulated alkali material, acid material, metallic cation and/or salt may be formed by any encapsulation technique known in the art including without limitation granulation techniques (dry and wet granulation) or other encapsulating methods such as spray congealing process etc. The resulting first encapsulated material, normally in the form of particles, may be encapsulated again in a second encapsulating material such as a fat and/or wax as described previously. For example, the first encapsulated particles may be encapsulated again in the second encapsulating material (such as fat and/or wax) by incorporating it in a melted fat and/said first encapsulated particles as described before.

In certain embodiments, the pigments may be also encapsulated by is encapsulated by one or more of the following techniques: granulation techniques (including both dry and wet granulation), spray congealing, melt emulsification, inclusion.

In certain embodiments, the pigment may be encapsulated together with the material (alkali material, acid material, metallic cation and/or salt) in the same encapsulating material. For example, the pigment the material (alkali material, acid material, metallic cation and/or salt) may be encapsulated together with the in a fat or wax block simultaneously with the material (alkali material, acid material, metallic cation and/or salt) by inclusion as defined before. This is by directly incorporate the material (alkali material, acid material, metallic cation and/or salt) and the pigment or pigments in a melted fat and/or wax, mixed by standard means so as to provide a material that is homogenously distributed in the mass of the fat and/or wax.

In certain embodiments, the material (alkali material, acid material, metallic cation and/or salt) is first encapsulated using one or more of one or more of the following techniques: granulation techniques (including both dry and wet granulation), spray congealing, melt emulsification and then included in a fat and/or wax block.

In certain embodiments, the pigment, the pigment (such as a blend of different pigments such as one or more of phycoerythrobilins, such as phycoerythrin; anthocyanins, such as pelargonidin, cyanidin and peonidin-based anthocyanins; betalains, such as betacyanins, betaxanthins; caramels; caramelized fruit and vegetables juices; burnt sugars and caramel colors; carotenoids, such as lycopene, paprika extract, bixins, norbixins, etc; malt; sorghum; fruit juice extracts; iron oxide colors; chlorophylls; metal substituted chlorophylls; chlorophyllin; metal substituted chlorophyllins; azaphilones; melanin; indigodine; monascin; anthraquinones, or mixtures thereof) and the material (alkali material, acid material, metallic cation and/or salt) is first encapsulated using one or more of one or more of the following techniques: granulation techniques (including both dry and wet granulation), spray congealing, melt emulsification and then further encapsulated by inclusion in a fat and/or wax block.

In certain embodiments, the pigment, the pigment (such as a blend of different pigments such as one or more of phycoerythrobilins, such as phycoerythrin; anthocyanins, such as pelargonidin, cyanidin and peonidin-based anthocyanins; betalains, such as betacyanins, betaxanthins; caramels; caramelized fruit and vegetables juices; burnt sugars and caramel colors; carotenoids, such as lycopene, paprika extract, bixins, norbixins, etc; malt; sorghum; fruit juice extracts; iron oxide colors; chlorophylls; metal substituted chlorophylls; chlorophyllin; metal substituted chlorophyllins; azaphilones; melanin; indigodine; monascin; anthraquinones, or mixtures thereof) and the material (alkali material, acid material, metallic cation and/or salt) are encapsulated separately using one or more of one or more of the following techniques: granulation techniques (including both dry and wet granulation), spray congealing, melt emulsification and then further encapsulated together by inclusion in a fat and/or wax block.

In certain embodiments, the encapsulated the encapsulated alkali material, acid material, metallic cation and/or salt is encapsulated again in a second encapsulating medium. For example, the encapsulated alkali material, acid material, metallic cation and/or salt may be incorporated in a melted fat and/or wax, then mixed by standard means so as to provide a fat or wax where the encapsulated the encapsulated alkali material, acid material, metallic cation and/or salt is homogenously distributed in the mass of the fat and/or wax. If needed, the solid fat and/or wax (that comprises the first encapsulated alkali material, acid material, metallic cation and/or salt) could then be cut or shredded in the required particle size.

In embodiments of the invention, the encapsulating media has a melting point from about 50° C. to about 70° C., or from about 50° C. to about 65° C., or from about 50° C. to about 60° C., or from about 50° C. to about 55° C., or from about 55° C. to about 65° C., or from about 58° C. to about 62° C. This melting point range is particularly effective when the colourant composition is intended to be used to colour meat analogue products, such as beef burger patties as the melting temperature of the encapsulating medium corresponds to the temperature of plant-based meat analogue products during standard pan-frying conditions.

During standard pan frying conditions of meat analogue products, such as a plant-based burger patty, the core of the patty reaches a temperature between about 71° C. and about 74° C. According to a particular embodiment, a colorant composition comprises spray congealed droplets of alkali material encapsulated within hydrogenated palm oil with a melting point substantially below the core temperature, such as about 58 C to about 62 C, to ensure the alkali material, acid material, metallic cation and/or salt is released early enough in the frying step to ensure complete release.

According to a particular embodiment, a colourant composition comprises spray congealed droplets of acid material encapsulated within hydrogenated palm oil with a melting point substantially below the core temperature, such as about 24° C. to about 62° C., such as from about 58° C. to about 62° C., to ensure the alkali material, acid material, metallic cation and/or salt is released early enough in the frying step to ensure complete release.

As the person skilled in the art recognizes, the concentration of alkali and/or acid material that is encapsulated will vary in function of the desired pH reduction or increase in the final product where the colourant is going to be incorporated. The desired pH (reduction or increase of pH) will depend on the pigment used and the change in colour hue that is desired. Also, as the person skilled in the art recognizes, the concentration of the pigment in the colourant composition of the invention may vary in function of the colour hue and brightness desired.

In certain embodiments, the colourant composition comprises phycoerythrin at a concentration of at least 0.03% w/w of the final colourant composition and an alkali (such as sodium bicarbonate) in a concentration of from 0.17 to 0.85% w/w and wherein the alkali is encapsulated for example using fully hydrogenated vegetable oil (such as Palm oil, coconut oil etc). In certain embodiments, the encapsulated alkali is encapsulated again in a second encapsulating medium. For example, the encapsulated alkali may be incorporated in a melted fat and/or wax, then mixed by standard means so as to provide a fat or wax where the encapsulated alkali is homogenously distributed in the mass of the fat and/or wax. If needed, the solid fat and/or wax (that comprises the first encapsulated alkali material) could then be cut or shredded in the required particle size.

In certain embodiments, the colourant composition comprises anthocyanin at a concentration of at least 0.03% w/w of the final colourant composition and an alkali (such as sodium bicarbonate) in a concentration of from 0.17 to 0.85% w/w and wherein the alkali is encapsulated for example using fully hydrogenated vegetable oil (such as Palm oil, coconut oil etc). In certain embodiments, the encapsulated alkali is encapsulated again in a second encapsulating medium. For example, the encapsulated alkali may be incorporated in a melted fat and/or wax, then mixed by standard means so as to provide a fat or wax where the encapsulated alkali is homogenously distributed in the mass of the fat and/or wax. If needed, the solid fat and/or wax (that comprises the first encapsulated alkali material) could then be cut or shredded in the required particle size.

In certain embodiments, the colourant composition comprises betanin at a concentration of at least 0.01% w/w of the final colourant composition and an alkali (such as sodium bicarbonate) in a concentration of at least 5%, such as from 10 to 90% w/w and wherein the alkali is encapsulated for example using fully hydrogenated vegetable oil (such as Palm oil). In certain embodiments, the encapsulated alkali is encapsulated again in a second encapsulating medium. For example, the encapsulated alkali may be incorporated in a melted fat and/or wax, then mixed by standard means so as to provide a fat or wax where the encapsulated alkali is homogenously distributed in the mass of the fat and/or wax. If needed, the solid fat and/or wax (that comprises the first encapsulated alkali material) could then be cut or shredded in the required particle size.

In certain embodiments, the colourant composition comprises betanin (such as a Red Beet Juice Concentrate), a vulgaxanthin (such as a yellow beet juice concentrate) and malt, and an alkali (such as sodium bicarbonate) in a concentration of at least 5%, such as from 10% to 90% w/w and wherein the alkali is encapsulated for example using fully hydrogenated vegetable oil (such as Palm oil). In certain embodiments, the encapsulated alkali is encapsulated again in a second encapsulating medium. For example, the encapsulated alkali may be incorporated in a melted fat and/or wax, then mixed by standard means so as to provide a fat or wax where the encapsulated alkali is homogenously distributed in the mass of the fat and/or wax. If needed, the solid fat and/or wax (that comprises the first encapsulated alkali material) could then be cut or shredded in the required particle size.

In certain embodiments, the colourant composition comprises phycoerythrin at a concentration at least 0.01% w/w of the final colourant composition and an alkali (such as sodium bicarbonate) in a concentration of at least 5%, such as from 10 to 90% w/w and wherein the alkali is encapsulated for example using fat and/or wax (such as Palm oil, coconut oil etc). For example, the alkali may be incorporated in a melted fat and/or wax, then mixed by standard means so as to provide a fat or wax where the alkali is homogenously distributed in the mass of the fat and/or wax. If needed, the solid fat and/or wax (that comprises the alkali material, now encapsulated in the fat and/or wax) could then be cut or shredded in the required particle size.

In certain embodiments, the colourant composition comprises anthocyanin at a concentration at least 0.01% w/w of the final colourant composition and an alkali (such as sodium bicarbonate) in a concentration of at least 5%, such as from 10 to 90% w/w and wherein the alkali is encapsulated for example using fat and/or wax (such as Palm oil, coconut oil etc). For example, the alkali may be incorporated in a melted fat and/or wax, then mixed by standard means so as to provide a fat or wax where the alkali is homogenously distributed in the mass of the fat and/or wax. If needed, the solid fat and/or wax (that comprises the alkali material, now encapsulated in the fat and/or wax) could then be cut or shredded in the required particle size.

In certain embodiments, the colourant composition comprises betanin at a concentration at least 0.01% w/w of the final colourant composition and an alkali (such as sodium bicarbonate) in a concentration of at least 5%, such as from 10 to 90% w/w and wherein the alkali is encapsulated for example using for example using fat and/or wax (such as Palm oil, coconut oil etc). For example, the alkali may be incorporated in a melted fat and/or wax, then mixed by standard means so as to provide a fat or wax where the alkali is homogenously distributed in the mass of the fat and/or wax. If needed, the solid fat and/or wax (that comprises the alkali material, now encapsulated in the fat and/or wax) could then be cut or shredded in the required particle size.

In certain embodiments, the colourant composition comprises betanin (such as a Red Beet Juice Concentrate), a vulgaxanthin (such as a yellow beet juice concentrate) and malt, and an alkali (such as sodium bicarbonate) in a concentration of at least 5%, such as from 10 to 90% w/w, and wherein the alkali is encapsulated for example using for example using fat and/or wax (such as Palm oil, coconut oil etc). For example, the alkali may be incorporated in a melted fat and/or wax, then mixed by standard means so as to provide a fat or wax where the alkali is homogenously distributed in the mass of the fat and/or wax. If needed, the solid fat and/or wax (that comprises the alkali material, now encapsulated in the fat and/or wax) could then be cut or shredded in the required particle size.

According to certain illustrative embodiments, the colourant composition may further include one or more additional pigments. In certain embodiments those pigments are not thermally and/or pH sensitive pigments, including but not limited to brown colours like caramels, caramelized fruit and vegetables juices, burnt sugars and caramel colors, carotenoids (such as lycopene, paprika extract, bixins, norbixins, etc), malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, or mixtures thereof.

In certain embodiments, the colors may also be encapsulated in an encapsulating material (such as fat and/or wax). In certain embodiments the colors may be encapsulated together or separately to the alkali material, acid material, metallic cation and/or salt.

Final colour is based on the sensitive pigment such as anthocyanin, betanin and phycoerythrin (that will be at the origin of the color change), which can be blended with brown colours like caramels, caramelized fruit and vegetables juices, burnt sugars and caramel colors, carotenoids (such as lycopene, paprika extract, bixins, norbixins, etc), malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, or mixtures thereof. The second group of pigments are normally used to balance the colour of the product before and after the energetic process (such as application of heat and/or mechanical energy)

In certain embodiments, the mixture of colourants will provide an initial colour hue of L* 37.16, a* 8.52, b* 14.63 or L* 52.23, a* 4.37, b* 12.39.

According to certain illustrative embodiments, the colourant composition may further include one or more additional functional ingredients that singly or in combination are useful in the creation, modification or improvement of an organoleptic effect in food or beverage products, such as the creation, modification or improvement of flavour, texture, appearance, colour or quality of said products.

In certain embodiments, the colourant composition of the invention may further comprise one or more of maltodextrin, sugars, polysaccharides such as gums: Arabic, guar gum, xanthan gum and glycerol, clarified fruit and vegetables juices, starch etc.

In one aspect the present invention provides kit for preparing a composition as defined herein or to perform the methods described herein, the kit comprising
(a) a pigment as described herein, and
(b) an alkali material, acid material, metallic cation and/or salt encapsulated in an encapsulating medium, in separate packages or containers; optionally with instructions for admixture and/or contacting and/or use.

In preferred embodiments, the pigment of the kit is one or more of phycoerythrobilins (such as phycoerythrin), anthocyanins (such as pelargonidin, cyanidin and peonidin-based anthocyanins), betalains (such as betacyanins, betaxanthins), caramels, caramelized fruit and vegetables juices, burnt sugars and caramel colors, carotenoids (such as lycopene, paprika extract, bixins, norbixins, etc), malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, or mixtures thereof.

Thus, the invention relates to a method for colouring a product (such as a food or beverage product) comprising the step of the simultaneous, separate or sequential addition of a pigment and an encapsulated alkali material, acid material, metallic cation and/or salt to said product.

In certain embodiments, the alkali material, acid material, metallic cation and/or salt is encapsulated by one or more of the following techniques: granulation techniques (including both dry and wet granulation), spray congealing, melt emulsification, inclusion.

In certain embodiments, the material (alkali material, acid material, metallic cation and/or salt) may be encapsulated by inclusion, as previously defined. This is by directly incorporate the material (alkali material, acid material, metallic cation and/or salt) in a melted fat and/or wax, mixed by standard means so as to provide a material that is homogenously distributed in the mass of the fat and/or wax.

In certain embodiments, the pigment and the material (alkali material, acid material, metallic cation and/or salt) may be encapsulated together in the same encapsulating material. For example, the pigment may be encapsulated together with the in a fat or wax block simultaneously with the material (alkali material, acid material, metallic cation and/or salt) by inclusion as defined before. This is by directly incorporate the material (alkali material, acid material, metallic cation and/or salt) and the pigment or pigments in a melted fat and/or wax, mixed by standard means so as to provide a material that is homogenously distributed in the mass of the fat and/or wax.

In certain embodiments, the material (alkali material, acid material, metallic cation and/or salt) is first encapsulated using one or more of one or more of the following techniques: granulation techniques (including both dry and wet granulation), spray congealing, melt emulsification and then included in a fat and/or wax block.

In certain embodiments, the pigment (such as a blend of different pigments such as one or more of phycoerythrobilins, such as phycoerythrin; anthocyanins, such as pelargonidin, cyanidin and peonidin-based anthocyanins; betalains, such as betacyanins, betaxanthins; caramels; caramelized fruit and vegetables juices; burnt sugars and caramel colors; carotenoids, such as lycopene, paprika extract, bixins, norbixins, etc; malt; sorghum; fruit juice extracts; iron oxide colors; chlorophylls; metal substituted chlorophylls; chlorophyllin; metal substituted chlorophyllins; azaphilones; melanin; indigodine; monascin; anthraquinones, or mixtures thereof) and the material (alkali material, acid material, metallic cation and/or salt) is first encapsulated using one or more of one or more of the following techniques: granulation techniques (including both dry and wet granulation), spray congealing, melt emulsification and then further encapsulated by inclusion in a fat and/or wax block.

In certain embodiments, the pigment, the pigment (such as a blend of different pigments such as one or more of phycoerythrobilins, such as phycoerythrin; anthocyanins, such as pelargonidin, cyanidin and peonidin-based anthocyanins; betalains, such as betacyanins, betaxanthins; caramels; caramelized fruit and vegetables juices; burnt sugars and caramel colors; carotenoids, such as lycopene, paprika extract, bixins, norbixins, etc; malt; sorghum; fruit juice extracts; iron oxide colors; chlorophylls; metal substituted chlorophylls; chlorophyllin; metal substituted chlorophyllins; azaphilones; melanin; indigodine; monascin; anthraquinones, or mixtures thereof) and the material (alkali material, acid material, metallic cation and/or salt) are encapsulated separately using one or more of one or more of the following techniques: granulation techniques (including both dry and wet granulation), spray congealing, melt emulsification and then further encapsulated together by inclusion in a fat and/or wax block.

Food and beverages products containing colourant compositions described herein represent the second aspect of the invention.

The food and beverage products comprise an edible base and the colourant composition as herein described.

All manner of food or beverage products can be used in combination with the colourant composition, including but not limited to the following general food categories, as defined by the Food and Drug Administration (FDA): baked goods and baking mixes, including all ready-to-eat and ready-to-bake products, flours, and mixes requiring preparation before serving; beverages, alcoholic, including malt beverages, and cocktail mix; beverages and beverage bases, non-alcoholic, including only special or spiced teas, soft drinks, coffee substitutes, and fruit and vegetable flavoured gelatin drinks; cheeses, including curd and whey cheeses, cream, natural, grating, processed, spread, dip, and miscellaneous cheeses; chewing gum, including all forms; coffee and tea, including regular, decaffeinated, and instant types; condiments and relishes, including plain seasoning sauces and spreads, olives, pickles, and relishes, but not spices or herbs; confections and frostings, including candy and flavoured frosting, marshmallows, baking chocolate, and brown, lump, rock, maple, powdered, and raw sugars; toppings, and other nondairy products; egg products, including liquid, frozen, or dried eggs, and egg dishes made therefrom, i.e., egg roll, egg foo young, egg salad, and frozen multicourse egg meals, but not fresh eggs; fats and oils, including margarine, dressings for salads, butter, salad oils, shortenings and cooking oils; fish products, including all prepared main dishes, salads, appetizers, frozen multicourse meals, and spreads containing fish, shellfish, and other aquatic animals, but not fresh fish; fresh eggs, including cooked eggs and egg dishes made only from fresh shell eggs; fresh fish, including only fresh and frozen fish, shellfish, and other aquatic animals; fresh meats, including only fresh or home-frozen beef or veal, pork, lamb or mutton and home-prepared fresh meat-containing dishes, salads, appetizers, or sandwich spreads made therefrom; fresh poultry, including only fresh or home-frozen poultry and game birds and home-prepared fresh poultry-containing dishes, salads, appetizers, or sandwich spreads made therefrom; pastas, including macaroni and noodle products, rice dishes, and frozen multicourse meals, without meat or vegetables; gravies and sauces, including all meat sauces and gravies, and tomato, milk, buttery, and specialty sauces; herbs, seeds, spices, seasonings, blends, extracts, and flavourings, including all natural and artificial spices, blends, and flavours; meat products, including all meats and meat containing dishes, salads, appetizers, frozen multicourse meat meals, and sandwich ingredients prepared by commercial processing or using commercially processed meats with home preparation; milk, whole and skim, including only whole, lowfat, and skim fluid milks; milk products, including flavoured milks and milk drinks, dry milks, toppings, snack dips, spreads, weight control milk beverages, and other milk origin products; plant protein products, including the National Academy of Sciences/National Research Council “reconstituted vegetable protein” category, and meat, poultry, and fish substitutes, analogues, and extender products made from plant proteins; poultry products, including all poultry and poultry-containing dishes, salads, appetizers, frozen multicourse poultry meals, and sandwich ingredients prepared by commercial processing or using commercially processed poultry with home preparation; all commercially processed vegetables, vegetable dishes, frozen multicourse vegetable meals, and vegetable juices and blends; snack foods, including chips, pretzels, and other novelty snacks; soups, home-prepared, including meat, fish, poultry, vegetable, and combination home-prepared soups; soups and soup mixes, including commercially prepared meat, fish, poultry, vegetable, and combination soups and soup mixes.

More particularly, the invention relates to food and beverages products adapted to change colour when heated, for example, meat analogue products.

A meat analogue product can be a plant-based meat product, a product comprising cultivated meat cells (so-called, lab grown meat or cultivated meat), or a hybrid product comprising an edible base containing both plant based meat and cultivated meat cells.

In particular embodiments of the invention, meat analogue products comprise a non-animal edible base and the colourant composition. The meat analogue product may comprise a plant-derived protein base. Without limitation, the plant-derived protein base may comprise a textured vegetable protein.

A meat analogue may comprise one or more carbohydrates. Preferably, the one or more carbohydrates are selected from monosaccharides and/or disaccharides. In particular embodiments, the one or more carbohydrates are selected from the group consisting of glucose, ribose, fructose, lactose, xylose, arabinose, maltose, galactose, or mixtures thereof.

Meat analogue products may further comprise one or more flavour ingredients that may include but are not limited kitchen salt, glutamate, inosine monophosphate, adenosine monophosphate, guanosine monophosphate, and combinations thereof.

Meat analogue products may further comprise one or more lipids that may include but are not limited to vegetable oil, algal oil, sunflower oil, corn oil, soybean oil, palm oil, safflower oil, flaxseed oil, olive oil, coconut oil, cottonseed oil, or combinations thereof.

Meat analogue product of the present invention may further comprise one or more plant or vegetable proteins. Such proteins refer to protein preparations made from materials that can include, but are not limited to grain (rice, millet, maize, barley, wheat, oat, sorghum, rye, teff, triticale, amaranth, buckwheat, quinoa); legume or pulses, beans (such as soybean, mung beans, fava beans, lima beans, runner beans, kidney beans, navy beans, pinto beans, azuki beans, and the like), peas (such as green peas, yellow peas, chickpeas, pigeon peas, cowpea, and black-eyed peas and the like), sesame, garbanzo, potatoes, lentils, and lupins; seed and oilseed (black mustard, India mustard, rapeseed, canola, safflower, sunflower seed, flax seed, hemp seed, poppy seed, pumpkin, chia, sesame); nuts (almond, walnut, Brazil, Macadamia, cashews, chestnuts, hazelnuts, pine, pecans, peanuts, pistachio and gingko); algal (kelp, wakame, spirulina, chlorella); mycoprotein and/or fungal protein.

Plant or vegetable proteins may be textured or texturized. These products typically comprise a defatted plant/vegetable protein flour, such as soy flour, which can be processed, for example by extrusion into chunks or flakes. The plant/vegetable proteins can include but are not limited to any of those proteins referred to above, and in particular soybean protein, wheat gluten protein, pea protein, lentil protein, lupin bean protein, green bean protein, chickpea protein, canola protein, black bean protein, red bean protein, favabean proteins, or mixtures thereof.

Meat analogue product according to the present invention may be fashioned into any desirable 3D form, such as a burger patty, sausage, sausage links, meat loaf, meat ball, minced meat, nuggets, steaks, filets, roasting joints and the like. Meat analogues products according to the present invention may mimic different particular meat such as beef, poultry, pork etc. Meat analogue product according to the present invention also includes fish analogues and seafood analogues. Fish analogues may be fashioned into any desirable 3D form and will may mimic different particular fish meat, e.g., salmon, tuna, etc. In certain embodiments the meat analogue is a tuna fish analogue.

In certain embodiments, the colour of the product is stable when storage under cooling conditions, for example for at least 3 days, such as at least 4, 5, 6, 7, 8, 9, 10 days.

The third aspect of the invention relates to methods of incorporating the colourant composition to a food or beverage product.

Thus, the invention relates to a method of incorporating a colourant composition as defined herein into a food or beverage product, the method comprising the step of the simultaneous, separate or sequential addition of a pigment and an encapsulated alkali material, acid material, metallic cation and/or salt to said product.

In certain embodiments, the colour of the product is stable when storage under cooling conditions, for example for at least 3 days, such as at least 4, 5, 6, 7, 8, 9 or at least 10 days.

The colourant composition may be used to in the preparation of a wide variety of non-animal based food and beverage products, and in particular meat analogue products.

The colourant composition is added in a sufficient amount to a food or beverage product in order to enable the creation of desirable colour transition in the product when processed, e.g. cooked. In the case of meat analogue products, the amount must be sufficient to create a colour and colour change that mimics the aesthetic qualities of real meat products when they are cooked. A desirable amount can be established using only routine experimentation. Typically, however, one can incorporate up to 10 weight percent, more particularly up to 5 weight percent, based on the total weight of the product. According to certain embodiments, the colouring composition may be included into a product in an amount of 10 weight percent, or 9 weight percent, or 8 weight percent, or 7 weight percent, or 6 weight percent, or 5 weight percent, or 4 weight percent, or 3 weight percent, or 3 weight percent, or 1 weight percent, or 0.9 weight percent, or 0.8 weight percent, or 0.7 weight percent, or 0.6 weight percent, or 0.5 weight percent, or 0.4 weight percent, or 0.3 weight percent, or 0.2 weight percent, or 0.1 weight percent, or 0.05 weight percent, or 0.01 weight percent based on the total weight of the product.

In accordance with particular embodiments of this aspect of the invention, the pigment and encapsulated alkali material, acid material, metallic cation and/or salt may be pre-mixed before being incorporated into an edible base to create the food or beverage product. Alternatively, the pigment and encapsulated alkali material, acid material, metallic cation and/or salt components may be added separately to an edible base to form the colourant composition in-situ, in any order of addition, including simultaneous addition of each component. A similar consideration applies to the addition of other functional ingredients referred to hereinabove, that is, other functional ingredients may be pre-mixed with the colourant composition, or they may be added separately, again, in any order of addition.

In certain embodiments of the method, the pigment and the encapsulated alkali material, acid material, metallic cation and/or salt are incorporated simultaneously in form of a composition of the invention as defined herein.

In certain embodiments of the method, the pigment and the encapsulated alkali material, acid material, metallic cation and/or salt are incorporated sequentially to the product.

In certain embodiments, the pigment is incorporated first and the encapsulated alkali material, acid material, metallic cation and/or salt are incorporated after. In other embodiments, the encapsulated alkali material, acid material, metallic cation and/or salt are incorporated first to the product, and the pigment is incorporated afterwards.

In certain embodiments, when the production of the product includes mixing steps or application of other mechanical forces, it is preferred that the encapsulated alkali material, acid material, metallic cations and/or salts is added at the end of the process to avoid damage the encapsulating medium by mixing and/or temperatures.

In certain embodiments, when the product is a meat analogue, the pigments are typically solubilised in the water used to hydrate dry protein typically employed. Encapsulated alkali material, acid material, metallic cations and/or salts may be added at the end of the process to avoid damage to encapsulated material by excessive mixing and/or temperatures.

In accordance with particular embodiments of the invention the edible base comprises a plant-derived protein, as more fully described herein above. The edible base and colourant composition mixture can thereafter be fashioned into any desirable 3D form, as mentioned herein above.

The colourant composition may be incorporated into a food or beverage product by any convenient means of manufacture, such as by means of additive manufacturing or 3D printing. In the case of a 3D printed product, a digital image of a product, for example a burger patty, sausage or nugget, can be created with 3D modelling computer software. The 3D model of the digital file can then be sliced into many thin layers using slicing software and converted into a set of instructions in machine readable language for the 3D printer to execute. The digital file with the set of instructions in machine readable code is communicated to additive manufacturing equipment (i.e., a 3D printer), and the printer proceeds in accordance with the instructions received to print the product by laying down successive thin layers of product through one or more nozzles.

In accordance with the fourth aspect of the invention a method is provided for effecting a colour change in a food or beverage product.

Thus the invention is related to a method of effecting a colour change in a food or beverage product as define herein, the method comprising the step of a) simultaneously, separately or sequentially adding a pigment and an encapsulated alkali material, acid material, metallic cation and/or salt to the edible base, and b) submitting the food or beverage product obtained in step a) to a stimuli, such as an energetic process, including the application of heat and/or mechanical energy to release the encapsulated alkali material, acid material, metallic cation and/or salt. The color change in a food or beverage product results from the degradation or alternation of the pigment by the alkali material, acid material, metallic cation and/or salt after the release of said alkali material, acid material, metallic cation and/or salt in to the edible base.

In certain embodiments of the method, in step a) the pigment and the encapsulated alkali material, acid material, metallic cation and/or salt are incorporated simultaneously in form of a composition of the invention as defined herein.

In certain embodiments of the method, in step a) the pigment and the encapsulated alkali material, acid material, metallic cation and/or salt are incorporated sequentially to the product. In certain embodiments, the pigment is incorporated first and the encapsulated alkali material, acid material, metallic cation and/or salt are incorporated after. In other embodiments, the encapsulated alkali material, acid material, metallic cation and/or salt are incorporated first to the product, and the pigment is incorporated afterwards.

In certain embodiments, when the production of the product includes mixing steps or application of other mechanical forces, it is preferred that the encapsulated alkali material, acid material, metallic cations and/or salts is added at the end of the process to avoid damage to the encapsulating medium by excessive mixing and/or temperatures.

In certain embodiments, when the product is a meat analogue, the pigments are typically solubilised in the water used to hydrate a dry protein typically employed. Encapsulated alkali material, acid material, metallic cations and/or salts should be added at the end of the process to avoid damage to the fat coating by excessive mixing and/or temperatures.

The energetic process of to which the product is submitted (such as the application of heat and/or mechanical energy) would release the alkali material, acid material, metallic cation and/or salt. Then the contact between the pigment present in the edible base and the alkali material, acid material, metallic cation and/or salt that is release will surprisingly produce the colour change of in the edible base. As mentioned herein, the pigments used in the present invention that may be sensitive to one or more of alkali material, acid material, metallic cation and/or salt and as demonstrated by the examples 4 to 11 of the present invention there is a desirable and efficient colour transition.

The invention is also directed to the use of an encapsulated alkali material, acid material, metallic cations and/or salts to affect a colour change in a food or beverage product, the product comprising a colourant composition as defined herein, wherein the colour change is affected when the product is subjected to a stimulus, such as the application of heat or mechanical energy.

The invention is also directed to the use of an encapsulated alkali material, acid material, metallic cations and/or salts to affect a colour change in a food or beverage product, the food or beverage product comprising an encapsulated alkali material, acid material, metallic cations and/or salts as defined herein and one or more pigments that are sensitive to pH, temperature, metallic cations and/or ionic strength, and optionally other pigments that are not sensitive to pH, temperature, metallic cations and/or ionic strength, wherein the colour change is affected when the product is subjected to a stimulus, such as the application of heat or mechanical energy.

The colour change within a food or beverage product is effected by an increase and/or decrease in pH of the product triggered by the release of alkali material, acid material, metallic cations and/or salts from its encapsulating medium. The release of alkali material, acid material, metallic cations and/or salts is caused by a stimulus applied to the product, such as the application of heat during a cooking process.

At least one pigment employed in the colourant composition should be pH-sensitive and/or sensitive to metallic cations and/or ionic strength salts. Preferred pigments in this regard are selected from the phycoerythrins, betalains and anthocyanins. It is characteristic of these pigments that they exhibit a red-pink colour at room temperature. However, when heated to temperatures of 75° c. or above they thermally degrade and the chromatic properties change such that the red-pink colouration fades. This degradation is accelerated at pH levels above 6.5. As stated above, one can exploit the change in the chromatic properties of these pigments to mimic the loss of the raw red colour of meat as it is cooked. As the red colour fades, other components in the colorant or in the edible base, including, as necessary, complementary food pigments (such as caramels, caramelized fruit and vegetables juices, burnt sugars and caramel colors, malt, carotenoids such as lycopene, paprika extract, bixins, norbixins, etc, malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, santalin, santalin complexed with metals or mixtures thereof) that can assist in the creation of the classic brown-grey appearance of cooked meat.

The colour transition of food products can be analyzed with a spectrophotometer, and CIE L*a*b* values can be calculated from the spectral data, as described in greater detail below. As is well known in the art, L*a*b* values provide a means of representing colour characteristics and assessing the magnitude of difference between two colours.

For example, L*a*b* values consist of a set of coordinate values defined in a three-dimensional Cartesian coordinate system. L* is the lightness coordinate and provides a scale of lightness from black (0 L* units) to white (100 L* units) on a vertical axis. a* and b* are coordinates related to both hue and chroma. a* provides a scale for greenness (−a* units) to redness (+a* units), with neutral at the centre point (0 a* units), on a horizontal axis; b* provides a scale for blueness (−b* units) to yellowness (+b* units), with neutral at the center point (0 b* units), on a second horizontal axis perpendicular to the first horizontal axis. The three axes cross where L* has a value of 50 and a* and b* are both zero.

ΔE is a measure of the magnitude of total colour difference between two colours represented in CIELAB L*a*b* colour space. It has been reported that an experienced colour observer cannot distinguish any difference between two colours when the ΔE is about 2.3 or less. The ΔE of two different colours with L*a*b* values, L*1a*1b*1 and L*2a*2b*2, is calculated using the following equation:

$$Δ E = {( Δ {L}^{2} + Δ {a}^{2} + Δ {b}^{2} )}^{\%}$$

Accordingly, L*a*b* values provide a means of representing the initial colour characteristics of a food or beverage product containing a colourant composition, as well as assessing the magnitude of difference between the initial colour characteristics of the product and its colour after cooking, irrespective of whether the product is a solid or a liquid. Measurements of the colour characteristic s of a product in solid form can be accomplished using reflectance measurements from the surface of the product, according to techniques well known in the art.

For example, ΔE measurements are ΔE 2000

Phycoerythrins are light-harvesting protein pigments that are thermally unstable, and when heated they lose their native structure and their chromatic properties, their red-pink colouration fading over time, although colour fading can be accelerated in the presence of an alkali material.

In certain embodiments of the invention, the colourant comprises a phycoerythrin, betanin and/or anthocyanin, the edible base comprises plant/vegetable proteins, the encapsulated alkali is sodium bicarbonate, and the ΔE after the heat and/or mechanical energy is of at least 5, such as at least 6, at least 7, at least 8, such as at least 9.

Accordingly, in certain embodiments of the invention meat analogue products are provided containing a colourant composition comprising a phycoerythrin pigment, and an edible base comprising plant protein, water, salt, binders such as methyl cellulose and oils such as coconut oil and sunflower oil and complementary pigments selected from anthocyanin, pyranoanthocyanins, betalains, carotenoid, phycobilins, chlorophyll, chlorophyllin, caramels, caramelized vegetables and fruit juices, malt, wherein the L*a*b* values of the meat analogue product before cooking is 58.14, 16.37, 2.22, the L*a*b* value after cooking to T>75° C. degrees centigrade during at least 3, at least 4, at least 5, at least 7 at least 8 minutes total cooking time is 58.31, 11.87, 8.41, and the ΔE value is 6.23. When the phycoerythrin is blended with other pigments such as malt extract, the L*a*b* values of the meat analogue product before cooking is 53.36, 17.13, 9.03, the L*a*b* value after cooking to T>75° C. degrees centigrade during 8 minutes total cooking time is 48.02, 8.43, 10.51, and the ΔE value is 9.41.

Betalains, and in particular betanin, have been reported to thermally degrade through various degradation pathways such as decarboxylation, hydrolysis, auto-oxidation and deglycosylation, and this degradation affects their chromatic properties. As with the phycoerythrins, applicant has found that increasing pH accelerates the degradation and leads to significant colour fading on a time scale consistent with the cooking process of meat analogue products.

Accordingly, in certain other embodiments of the invention meat analogue products are provided containing a colourant composition comprising a betalain pigment, such a betanin, and an edible base comprising plant protein, water, salt, binders such as methyl cellulose and oils such as coconut oil and sunflower oil, and complementary pigments selected from anthocyanin, pyranoanthocyanins, betalains, carotenoid, phycobilins, chlorophyll, chlorophyllin, caramels, caramelised vegetables and fruit juices, and/or malt, wherein the L*a*b* values of the meat analogue product before cooking is 58.48, 19.22, 5.62, the L*a*b* value after cooking to T>75° C. degrees centigrade during 8 minutes total cooking time is 57.16, 11.32, 11.04, and the ΔE value is 8.08. When the betalain is blended with other pigments such as malt extract, the L*a*b* values of the meat analogue product before cooking is 51.40, 13.04, 9.36, the L*a*b* value after cooking to T>75° C. degrees centigrade during 8 minutes total cooking time is 48.29, 8.06, 10.99, and the ΔE value is 6.07.

Both the initial CIE L*a*b* value, and the value after cooking are measured according to the following technique: a 60 ml clear plastic pot suitable for use with a Konica Minolta CM-3600A that can be received by the spectrophotometer for measurement, and the spectrophotometer set to record in reflectance mode. For a sample of cooked patty, the core of the cooked patty is removed with a knife, taking care not to include any sample from the outer crust. L, a, b coordinates can be measured for both uncooked and cooked samples.

Anthocyanins are glycosides of the sugar-free anthocyanidins. The sugar molecules in anthocyanins are bound via O-glycosidic bonds to one or more of the hydroxy groups typically present in an anthocyanidin molecule. Most naturally, occurring anthocyanins are 3-O-glycosides. The stability of anthocyanin can be influenced by several factors such as pH, temperature, light, and oxygen. Anthocyanins are stable at acidic pH and exhibit a red colour. However, at higher pH values they exhibit a spectral shift (purple then blue to yellow at highly basic pH) followed by colour fading in time. The use of encapsulated alkali can accelerate this spectral shift to create an interesting colour change over a time scale consistent with the cooking process of meat analogue products.

Accordingly, in certain other embodiments of the invention meat analogue products are provided containing a colourant composition comprising an anthocyanin pigment, and an edible base comprising plant protein, water, salt, binders such as methyl cellulose and oils such as coconut oil and sunflower oil, and complementary pigments selected from anthocyanin, pyranoanthocyanins, betalains, carotenoid, phycobilins, chlorophyll, chlorophyllin, caramels, caramelised vegetables and fruit juices and/or malt, wherein the L*a*b* values of the meat analogue product before cooking is 61.53, 11.64, 5.81, the L*a*b* value after cooking to T>75° C. degrees centigrade during 8 minutes total cooking time is 56.47, 4.28, 4.74, and the ΔE value is 8.55. When the anthocyanin is blended with other pigments such as malt extract, the L*a*b* values of the meat analogue product before cooking is 55.38, 8.45, 10.29, the L*a*b* value after cooking to T>75° C. degrees centigrade during 8 minutes total cooking time is 50.76, 5.07, 8.34, and the ΔE value is 5.72.

Colour is measured in three dimensions, L, a, and b using the Hunter Lab colour scale and measuring with a spectrophotometer, such as a Konica Minolta CM-3600A.

When measuring the colour of a solid sample, such as a meat analogue patty, the patty can be compressed into a suitable receptacle (e.g. a 60 ml plastic pot suitable for use in a Konica Minolta CM-3600A) that can be received by the spectrophotometer for measurement, and the spectrophotometer set to record in reflectance mode. For a sample of cooked patty, any burned or charred material on the surface of the patty should be removed before sampling. L, a, b coordinates can be measured for both uncooked and cooked samples and delta E calculated. A delta E value of greater than 2 indicates that the human eye would see a significant difference between the colour shade of the 2 samples.

The invention further relates to a meat analogue product capable of changing colour when heated for at least 2 to 5 minutes, such as at least 4 min each side at a temperature of more than 75° C. and, wherein the initial colour is characterized by an L a b value of L* 37.16, a* 8.52, b* 14.63 or L* 52.23, a* 4.37, b* 12.39, and the colour change (delta E) between the initial colour and the cooked colour is higher than 3, such as higher than 4, or higher than 5.

The invention further relates to a meat analogue product having the ability to change colour when heated to a temperature of above 160° C., comprising (1) an edible substrate and (2) and a colourant composition comprising a pigment as defined herein and an encapsulated acid material, metallic cation and/or salt.

The invention further relates to the use of an encapsulated alkali material, acid material, metallic cation and/or salt to affect a colour change in a product (such as a food or beverage product), the product comprising a colourant composition as defined herein and encapsulated alkali material, acid material, metallic cation and/or salt, wherein the colour change is affected when the product is heated and/or submitted to mechanical energy.

The invention further relates to a method for colouring a food or beverage product comprising the step of the simultaneous, separate or sequential addition of a pigment as herein and an encapsulated alkali material, acid material, metallic cation and/or salt to said product. In certain embodiments, the pigment is a pigment sensitive to pH changes, sensitive to increase of temperature, sensitive to metallic cations and/or sensitive to increase of ionic strength. In other embodiments, the method may include a step of adding one of more pigments that are not pigment sensitive to pH changes, sensitive to increase of temperature, sensitive to metallic cations and/or sensitive to increase of ionic strength, such as the pigments described previously.

The invention further relates to the use of an encapsulated alkali material, acid material, metallic cation and/or salt to affect a colour change in a product (such as a food or beverage product), the product comprising a pigment sensitive to pH changes, sensitive to increase of temperature, sensitive to metallic cations and/or sensitive to increase of ionic strength, as defined herein, and the encapsulated alkali material, acid material, metallic cation and/or salt, wherein the colour change is affected when the product is heated and/or submitted to mechanical energy.

The present invention also relates to a product (such as a food or beverage product) obtained using the methods or uses described herein.

In the present invention, all embodiments that refer to only encapsulated alkali material may be extrapolated to encapsulated acid materials, metallic cation and/or salt.

The invention will be further explained and illustrated with reference to the following non-limiting examples.

### EXAMPLES

### Materials and Methods

Phycoerythrin is provided as extract from Porphyridium purpureum in dry powder form containing greater than 2 wt % B-phycoerythrin content.

Sodium bicarbonate E500: Dr Oetker Bicarbonate of soda.

Encapsulated alkali materially was BakeShure® 187 (F4187011B), containing approximately 83-87% of sodium bicarbonate encapsulated using fully hydrogenated vegetable oil (Palm oil).

Betanin extract was provided in the form of a concentrated juice of red beetroot (Beta vulgaris), spray dried onto a maltodextrin carrier with betanin content 0.28-0.32 wt %.

Anthocyanin was provided in the form of red radish maltodextrin powder (containing 15 wt % anthocyanin) formulated with water and glycerine. The pH was adjusted using citric acid (to pH 1.5-2.0) The final liquid formulation contained 3.5 to 4.3 wt % of anthocyanins.

Burger patty recipe and mixing instructions is shown below:

TABLE 1
Burger patty recipe

| | | |
|---|---|---|
| | | for 50 g patties |
| Ingredient | % | g |

Step 1

| | | |
|---|---|---|
| Cold tap water | 30.76 minus | 27.88 minus |
| | colour added | colour added |
| Colour | As required | − |
| Soy protein | 24.65 | 12.325 |
| Response 4438 | | |

Step 2

| | | |
|---|---|---|
| Cold tap water | 25 | 12.5 |
| Methylcellulose | 1.89 | 0.945 |
| Salt | 0.92 | 0.46 |

Step 3

| | | |
|---|---|---|
| Sunflower oil | 7.34 | 3.67 |
| Coconut oil | 6.29 | 3.145 |

Step 4

| | | |
|---|---|---|
| Vital wheat gluten | 3.15 | 1.575 |

### Step 1

Weigh colour(s) into glass mixing bowl. Add cold tap water at rate of 30.76% minus the % of colour added. For example, if adding 2% phycoerythrin extract then cold water equals 30.76 minus 2=28.76%. Fully dissolve/suspend the colours. Add soy protein. Mix well immediately to evenly coat all soy pieces with coloured water. Refrigerate for 30 minutes for soy TVP to hydrate.

### Step 2

Weigh methylcellulose and salt into glass mixing bowl. Add cold tap water and whisk until a white homogenous gel forms.

### Step 3

Weigh sunflower and coconut oils into suitable vessel, microwave to melt coconut oil and mix well.

Add to the gel mixture of step 2 and whisk until a homogenous paste if formed.

### Step 4

Add gluten to the hydrated, coloured soy protein and mix to coat.

Add the paste from step 3 and mix well until a combined mass.

Use a patty former to produce burger patties.

Refrigerate for a minimum of 45 minutes before cooking. Fry in a little sunflower oil for 4 minutes each side, on a medium-high heat. Core temperature will be >75° C.; pH typically 6.3-6.6.

The patties were made as per recipe and colours were incorporated at the dosages referred to in the examples.

Where sodium bicarbonate (whether or not encapsulated) was added at the dosages referred to in the examples, the addition was made after the patty mass was formed, and it was mixed into the patty for a further 30 seconds to 1 minute until homogenously distributed.

### Example 1. Acceleration of Phycoerythrin Thermal Degradation as a Function of pH

This example demonstrates the variation in phycoerythrin pigment degradation as a function of thermal treatment (80° C. for 30 minutes) at three different pH values.

Samples were prepared by dissolving 1 g of phycoerythrin powder (2 wt % of phycoerythrin) in aqueous buffers (100 mL) to investigate the impact of pH on heat sensitivity,

### Sample 1A:

1 g of phycoerythrin in 100 ml of phosphate buffer (PH7, 10 mM)

### Sample 1B:

1 g of phycoerythrin in 100 ml of phosphate buffer (PH6, 10 mM)

### Sample 1C:

1 g of phycoerythrin in 100 ml of phosphate buffer (PH5, 10 mM)

Initial L a b parameters were measured using a Konica Minolta spectrophotometer (CM-36dG), samples were then subjected to thermal treatment at 80° C. for 30 min in a water bath. After 30 minutes of heating, colour change was measured (deltaE 2000). In the present description Delta E is dE2000.

Results are shown in the table, below. The example demonstrates that increasing pH from 5 to 7 significantly increased the ΔE value (dE2000 colour change) after thermal treatment this suggests that increasing pH accelerates the thermal degradation. This synergistic effect of pH and temperature on phycoerythrin were unexpected.

Results are shown in the table, below. The example demonstrates that increasing pH from 5 to 7 accelerated significantly pigment degradation which was shown by colour fading measured by the increase of the colour change (dE2000) at high pH after thermal treatment. This experiment suggests that increasing pH accelerates the thermal degradation of phycoerythrin.

TABLE 2
Delta E value (heat treated sample compared
to sample before heat treatment)

| Sample | dE |
|---|---|
| 1A | 19.88 |
| 1B | 13.95 |
| 1C | 7.88 |

### Example 2. Application in Soy Protein Patties: Impact of pH Increase on Colour Transformation of Phycoerythrin-Containing Patties During Cooking

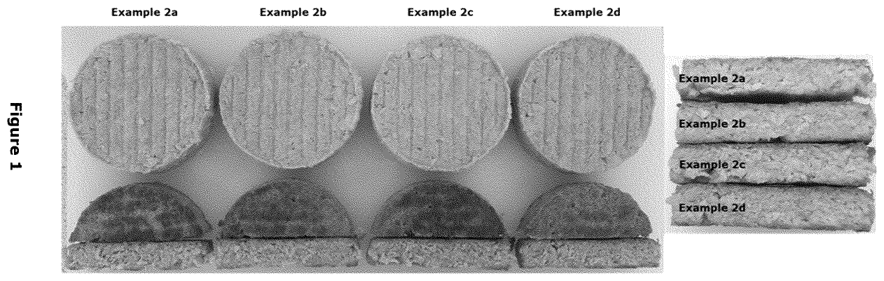

In this example the patties were prepared according to the recipe set out above. The patties contained 2 wt % of added phycoerythrin powder, and the pH was adjusted between patties by the addition of increasing amounts of sodium bicarbonate. Four patties were prepared: A first, containing no bicarbonate and having a pH of 6.4 (example 2a); a second containing bicarbonate and having a pH of 7.2 (example 2b); a third containing bicarbonate and having a pH of 7.5 (example 2c); and a fourth containing bicarbonate and having a pH of 8.2 (example 2d). The example shows as pH increases there is less pink colour left after cooking process (FIG. 1)

### Example 3. Application in Soy Protein Patties: Impact of pH Increase on Initial Colour During Shelf Life (Chilled Storage)

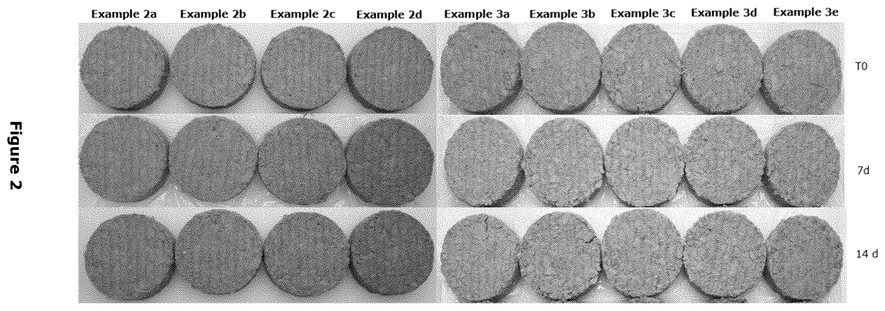

FIG. 2 A shows four patties (2a, 2b, 2c and 2d) were prepared as described in Example 2, above. The patties were stored, covered in cling film and under refrigerated conditions at <10° C. for 14 days before the colour of each patty was assessed.

The FIG. 2A shows over chilled storage the higher pH patty of example 2d (pH of 7.2) develops unacceptable blue tones, which would clearly negatively affect consumer perception if the products were placed on a supermarket shelf.

This demonstrates that alkali material in unencapsulated form has an undesirable effect on the shelf life of a product even under chilled storage conditions.

The experiment was repeated with 4 patties with different levels of added encapsulated sodium bicarbonate: Patty 3a with 2 wt % of added phycoerythrin powder that has no bicarbonate added; patty 3b has 2 wt % of added phycoerythrin powder+0.2 wt % of Bakeshure 187 added; patty 3c has 2 wt % of added phycoerythrin powder+0.3 wt % of Bakeshure 187 added; patty 3d has 2 wt % of added phycoerythrin powder+0.4 wt % of Bakeshure 187 added; and patty 3e has 2 wt % of added phycoerythrin powder+0.5 wt % of Bakeshure 187 added.

The encapsulated alkali material has a substantially reduced impact on the patty pH and therefore there is no colour shift at chilled storage conditions (FIG. 2 B).

### Example 4. Application in Soy Protein Patties: Impact of Use of Alkali Material on Colour Transformation of Phycoerythrin-Containing Patties During Cooking

This example uses identical patties to be set out in Example 3 above that have been subjected to the cooking process. The colour of the patties 3b to 3e is compared to that of patty 3a (containing no bicarbonate).

The results confirm that once alkali material is released from the encapsulation media upon cooking, the pH of the burger patty matrix increases, which leads to degradation of the pigment leading to colour change increase as a function of higher pH.

In order to measure delta E values of a patty mix, the crispy fried outer exterior of the patty is removed, and the inner soy protein matrix is filled into a 60 ml clear plastic pot, compressed with tissue paper and the colour recorded on a Konica Minolta CM-3600A in reflectance mode.

The ΔE values in the table X show that the alkali material is released after cooking and the higher the pH is, the higher a colour change is achieved because of increase degradation of phycoerythrin pigment. For example, sample 3b, which has a lower pH after cooking (7.6) has also a lower Delta E, while sample 3e which has a pH after cooking of 8.15, has a higher Delta E (6.23).

TABLE 3
Δ E values of the colour hue change from
before cooking and after cooking and pH change.

| | Delta E to | Raw (before | |
|---|---|---|---|
| Sample | example 3a cooked | cooking) pH | Cooked pH |
| Example 3a | Control | 6.5 | 6.41 |
| | without alkali | | |
| Example 3b | 2.29 | 6.65 | 7.06 |
| Example 3c | 4.78 | 6.62 | 7.44 |
| Example 3d | 5.31 | 6.64 | 7.86 |
| Example 3e | 6.23 | 6.73 | 8.15 |

This is confirmed by the pH values of the burger patties taken before and after cooking (table 3), showing that the alkali agent is released and increases the pH of the patty only after heat release of cooking step.

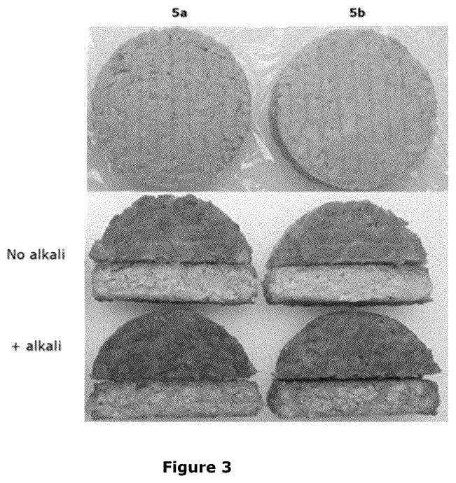

### Example 5. Application in Soy Protein Patties: Impact of Alkali Material on the Colour Transformation of Betanin- and Anthocyanin-Containing Patties During Cooking (FIG. 3)

Example 5a refers to a patty containing 0.8 wt % of beetroot powder colour with and without 0.5 wt % of Bakeshure 187.

Example 5b refers to a patty containing 0.2 wt % of red anthocyanin colour with and without 0.5 wt % of Bakeshure 187.

When the pH of the patty is increased to above 7 during the cooking step owing to release of alkali material from the encapsulating media, the betanin pigment degrades and a reduction in pink shade and development of brown-green colouration is observed thus in burger patties increasing the pH accelerates the degradation of extract (table 4)

The anthocyanin-containing patty exhibits a colour shift from pink-purple to purple-blue due to the structural change of flavylium cation (red) of anthocyanin to quinonoidal base (purple). (FIG. 3)

Both of these colour transitions can be leveraged in plant-based beef burgers to affect the transformation from a red/pink raw beef colour to a brown/grey cooked beef colour. (FIG. 3)

TABLE 4
pH measurement before and after cooking.

| | | | pH cooked with |
|---|---|---|---|
| | | pH cooked | 0.5 wt % |
| Sample | pH raw | no alkali | Bakeshure 187 |
| Example 5a | 6.48 | 6.38 | 7.37 |
| Example 5b | 6.35 | 6.26 | 7.11 |

### Example 6. Application in Soy Protein Patties: Impact of Alkali Material on the Colour Transformation of Blends of Betanin-Malt Extracts, Anthocyanin-Malt Extracts and Phycoerythrin-Malt Extracts Containing Patties During Cooking

Example 6a refers to a patty containing 0.8 wt % of beetroot powder colour, 0.3 wt % of malt extract with 0.5 wt % of Bakeshure 187 (encapsulated alkali).

Example 6b refers to a patty containing 2 wt % phycoerythrin powder colour, 0.3 wt % of malt extract with 0.5 wt % of Bakeshure 187 (encapsulated alkali).

Example 6c refers to a patty containing 0.4 wt % acidified red radish powder colour, 0.3 wt % of malt extract with 0.5 wt % of Bakeshure 187 (encapsulated alkali).

This results demonstrate that when the pH of the patty is increased to above 6.5 during the cooking step owing to release of alkali material from the encapsulating media, betanin, phycoerythrin and anthocyanin pigment degrade which help significantly colour transformation.

TABLE 5
Lab measurements and DE compared to the raw product.

| Sample | L | a | b | DE to raw |
|---|---|---|---|---|
| Beetroot Malt | 51.4 | 13.04 | 9.36 | — |
| RAW (6a) | | | | |
| Phycoerythrin Malt | 53.36 | 17.13 | 9.03 | — |
| RAW (6b) | | | | |
| Radish Malt | 55.38 | 8.45 | 10.29 | — |
| RAW (6c) | | | | |
| Beetroot Malt (6a) | 48.29 | 8.06 | 10.99 | 6.07 |
| COOKED | | | | |
| Phycoerythrin Malt | 48.02 | 8.43 | 10.51 | 9.41 |
| (6b) COOKED | | | | |
| Radish Malt (6c) | 50.76 | 5.07 | 8.34 | 5.72 |
| COOKED | | | | |

### Example 7. Encapsulation of Alkali Material in Fat Block

### Protocol:

### Phase 1

1. Weigh out water and color into a bowl and mix until dissolve
2. Weigh and add textured vegetable protein and soy protein isolate into same bowl and mix
3. Cover with plastic wrap and leave to hydrate in refrigerator for 30 minutes

### Binder

4. Weigh out water and cellulose and put into bowl or food processor.
5. Mix for 30 seconds, then add oil and mix again until white paste forms

### Phase 2

6. Add hydrated protein from Phase 1, binder, and dry ingredients from Phase 2 (textured vegetable protein, salt) in paddle mixer and mix for 5 minutes
7. Scrape down sides then add in coconut oil and mix again for 1-2 minutes

Cooking Process: Once burger patty is formed, pre-heat pan on stove to medium-high heat. Coat the pan generously with oil. Cook patty for 4 minutes on each side.

### Pigments

Red Beet Juice Concentrate. Pigment type—Betanin. 0.7% Betanin. Spray Dried Red Beet Color that is a water-soluble powder containing red beet color on a maltodextrin carrier. This product is produced using a clarified red beet juice concentrate that has gone through ultrafiltration. The Maltodextrin carrier is Identity Preserved.
Yellow Beet Juice Concentrate

Pigment type—Vulgaxanthin. 0.3% Vulgaxanthin. Spray Dried Yellow Beet Color that is a water-soluble powder containing yellow beet color on a maltodextrin carrier. This product is produced using a clarified yellow beet juice concentrate that has gone through ultrafiltration. The Maltodextrin carrier is Identity Preserved.
Malt

Extract of roasted barley malt, concentrated by vacuum evaporation, spray dried into a fine powder Color Units (EBC A430 nm)—28000-31000. Gluten <20 ppm.

Color Blend: 0.3% Red Beet Juice Concentrate, 0.2% Yellow Beet Juice Concentrate, 0.15% Malt

### Introduction of Bakeshure in Fat

Encapsulation of Bakeshure in a fat block. Bakeshure is a fat-encapsulated sodium bicarbonate powder (68-72% Sodium Bicarbonate)
Encapsulation of Sodium Bicarbonate in fat. Sodium Bicarbonate was also used on its own for the same effect. Based on the sodium bicarbonate load of the Bakeshure (68-72%), the Bakeshure provides 0.42 grams of sodium bicarbonate in the 0.6% use rate used in the burger patties. When sodium bicarbonate was used on its own, 0.42 grams was used to create equivalent use rates between the two products.

### Protocol for Incorporation

Bakeshure or sodium bicarbonate is added directly into coconut fat from Phase 2 in formula above
Hard Coconut fat is semi-melted down (15 seconds in microwave) and Bakeshure/Sodium Bicarbonate powder is added in and mixed well
Coconut fat is spread out on parchment and frozen until solid
Once solid, it is chopped up into small pieces and incorporated into the burger patty

TABLE 6
Formula for a patty.

| | |
|---|---|
| Ingredient | Weight (%) |

Phase 1

| | |
|---|---|
| Water | 34.81 |
| Color | |
| Textured Vegetable Protein | 15.5 |
| (Response 4410) | |
| Soy Protein Isolate | 4.58 |
| (Supro EX 33, 90% protein) | |

Binder

| | |
|---|---|
| Water | 27.61 |
| Food Grade Modified | 1.5 |
| Cellulose | |
| Canola/Sunflower Oil | 6.00 |

Phase 2

| | |
|---|---|
| Textured Vegetable Protein | 3.00 |
| (Response 4310) | |
| Salt | 1.00 |
| Coconut oil (refined) | 6.00 |
| Bakeshure/Sodium | 0.6/0.42 |
| Bicarbonate | |

TABLE 7
Lab measurements and DE.

| | L* | a* | b* | C* | h | dE CMC |
|---|---|---|---|---|---|---|
| A | | | | | | |
| Control (only color | 53.98 | 21.8 | 10.26 | 24.09 | 25.19 | |
| blend) - precooking | | | | | | |
| Post Cooking | 41.01 | 16.27 | 22.18 | 27.51 | 53.74 | 13.92 |
| B | | | | | | |
| Bakeshure - precooking | 55.95 | 19.89 | 9.18 | 21.91 | 24.77 | |
| Post Cooking | 34.87 | 13.72 | 19.15 | 23.56 | 54.39 | 15.08 |
| C | | | | | | |
| Sodium Bicarb Alone- | 53.82 | 18.47 | 9.07 | 20.58 | 26.16 | |
| precooking | | | | | | |
| Post Cooking | 34.33 | 11.93 | 19.63 | 22.97 | 58.7 | 15.76 |

Findings: The addition of Bakeshure or sodium bicarbonate yield a lower L value when incorporated into the burger as compared to the control. L value represents lightness and darkness. The lower the L value, the closer to black the sample is. The burgers had similar Lab values upon measurement before cooking. Post-cooking showed a higher dE CMC which signifies a larger change than the control and this change is mostly due to the difference in the L value as the burgers with Bakeshure/sodium bicarbonate appeared darker after the cooking process. A, b &c values are also slightly lower vs control and “h” higher indicating a less red shade closer to meat-like color.

### Example 8. Encapsulation of Alkali Material in Fat Block

Beef Burger Patties where Prepared Following the Protocol of Example 7 and Using the Pigments Defined in Tables 8, 9 and 10.

TABLE 8
% of pigments in examples 8A, 8B and 8C.

| | | % active | % in patty mass | | |
|---|---|---|---|---|---|
| Blends | % active | number | 8A | 8B | 8C |
| seneca red | 0.7% betanin | 0.7 | 0.25 | 0.15 | 0.25 |
| seneca | 0.3% | 0.3 | 0.3 | 0.1 | 0.6 |
| yellow | vulgaxanthin | | | | |
| amaize | 3-4% | 3.5 | 0.1 | 0.05 | 0.1 |
| | anthocyanin | | | | |
| naturbrown | — | — | 0.15 | 0.15 | 0.15 |
| apple 651 | | | | | |
| bakeshure 195 | 70% sodium | 70 | 0.6 | 0.6 | 0.6 |
| | bicarbonate | | | | |
| | Total | | 1.4 | 1.05 | 1.7 |

TABLE 9
% material in colour blend.

| | % material in | % material in | % material in |
|---|---|---|---|
| | colour blend | colour blend | colour blend |
| | 8A | 8B | 8C |
| seneca red | 17.86 | 14.29 | 14.71 |
| seneca yellow | 21.43 | 9.52 | 35.29 |
| amaize | 7.14 | 4.76 | 5.88 |
| naturbrown apple | 10.71 | 14.29 | 8.82 |
| (brown caramel | | | |
| from apple juice) | | | |
| 651 | | | |
| bakeshure 195 | 42.86 | 57.14 | 35.29 |
| total | 100.00 | 100.00 | 100.00 |

TABLE 10
% ACTIVE in colour blend

| | % ACTIVE in colour blend | | |
|---|---|---|---|
| | 8A | 8B | 8C |
| betanin | 0.13 | 0.10 | 0.10 |
| vulgaxanthin | 0.06 | 0.03 | 0.11 |
| anthocyanin | 0.25 | 0.17 | 0.21 |
| naturbrown apple | 10.71 | 14.29 | 8.82 |
| (brown caramel | | | |
| from apple juice) | | | |
| 651 | | | |
| sodium | 30.00 | 40.00 | 24.71 |
| bicarbonate | | | |

TABLE 11
DE measurements compared to before
and after cooking of beef burger.

| | 8A | 8B | 8C |
|---|---|---|---|
| DE before cooking | 4.69 | 8.37 | 4.31 |
| DE after cooking | 5.42 | 2.35 | 5.54 |

Findings: The addition of Bakeshure or sodium bicarbonate provided a color change when incorporated into the burger as compared to the control.

### Example 9. Application in Soy Protein Patties: Impact of Acid on Colour Transformation of Santalin-Containing Patties During Cooking

In this example the patties were prepared according to the recipe in Table 1 Burger patty recipe.

Example 9a refers to a patty containing 0.5% santalin extract liquid.

Example 9b refers to a patty containing 0.5% santalin extract liquid and 0.4% ascorbic acid powder.

Example 9c refers to a patty containing 0.5% santalin extract liquid and 0.67% of a fat encapsulated ascorbic acid with a 60% ascorbic acid loading.

Example 9d refers to a patty containing 0.5% santalin extract liquid and 2% of a fat encapsulated ascorbic acid with a 20% ascorbic acid loading.

The example shows as pH of the patty mass is decreased with the acid addition there is a degradation reaction of the santalin pigment during the heat of the cooking process and there is a loss of the pink colour after cooking (FIG. 9).

This degradation can help to achieve a pink colour loss effect on cooking as seen in real beef burgers from red to brown, when combined with brown colour pigments. The patty with non-encapsulated ascorbic acid (example 9b), had a change of color before the cooking. In the pattys with encapsulated ascorbic acid, the color change occurs only when the pattys are cooked.

### Example 10. Application in Soy Protein Patties: Impact of Alkali on Colour Transformation of Beet/Anthocyanin/Malt Blend Patties During Cooking

In this example, the soy protein patties are made according to the protocol outlined in Example 7.

FIG. 10a shows a raw soy protein patty containing a blend of colors including beet (0.25%), red anthocyanin (0.1%) and malt extract (0.25%). It also contains a fat encapsulated alkali (0.7%).

Upon heating, the fat coating of the alkali dissolves which causes a pH shift in the burger, resulting in FIG. 10b. The combination of the increased pH and the maillard browning due to the heating of the burger in a fry pan results in a color transformation that is similar to real meat due to degradation of the betanin compound and the increased browning from the malt extract.

### Example 11. Application in Soy Protein Patties: Impact of Alkali on Colour Transformation of Beet/Anthocyanin/Cooked Apple Juice Blend Patties During Cooking

In this example, the soy protein patties are made according to the protocol outlined in Example 7.

FIG. 11a shows a raw soy protein patty containing a blend of colors including beet (0.25%), red anthocya-nin (0.1%) and cooked apple juice concentrate (0.2%). This patty also contains the same encapsulated alkali (0.7%) as in Example 10.

When the burger is exposed to heat during the cooking process, the fat encapsulation of the alkali dissolves and the pH of the burger patty increases. This increase helps to degrade the betanin and when coupled with the maillard browning reaction, results in FIG. 11b. The outside of the patty and the inside have both transformed to result in a cooked burger look.

1. A colourant composition comprising a pigment and one or more of: an alkali material, an acid material, a salt, and a metallic cation, wherein the one or more of an alkali material, an acid material, a salt, and a metallic cation is encapsulated in an encapsulating medium.

2. The colourant composition according to claim 1, wherein the pigment is sensitive to pH changes, temperature changes, metallic cations and/or increase of ionic strength.

3. The colourant composition according to claim 1 wherein the pigment is selected from the group consisting of phycoerythrobilins, anthocyanins, betalains, santalin, santalin complexed with metal, or mixtures thereof.

4. The colourant composition according to claim 3, comprising one or more additional pigment materials selected from the group consisting of caramels, caramelized fruit and vegetables juices, burnt sugars, caramel colors, carotenoids, malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones or mixtures thereof.

5. The colourant composition according to claim 1, wherein the pigment is selected from the group consisting of phycoerythrobilins, anthocyanins, betalains, caramels, caramelized fruit and vegetables juices, burnt sugars, caramel colors, carotenoids, malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, santalin, santalin complexed with metal or mixtures thereof.

6. The colourant composition according to claim 3, wherein the phycoerythrobilins is a phycoerythrin obtained from Cyanophyceae.

7. The colourant composition according to claim 3, wherein the anthocyanin is obtained from red potato, black carrot, corn, grape, berries, hibiscus and/or red radish.

8. The colourant composition according to claim 3, wherein the betalain is a betain obtained from beetroot, Dragon fruit (Hylocereus) and/or cactus pear (Opuntia).

9. The colourant composition according to claim 1, wherein the one or more of: the alkali material, the acid material, the salt, and the metallic cation is encapsulated by one or more of the following techniques: granulation techniques, spray congealing, melt emulsification, inclusion.

10. The colourant composition according to claim 1, wherein the pigment is encapsulated by one or more of the following techniques: granulation techniques, spray congealing, melt emulsification, inclusion.

11. The colourant composition according to claim 10, wherein the pigment and the one or more of: the alkali material, the acid material, the salt, and the metallic cation are encapsulated together.

12. The colourant composition according to claim 1, wherein the encapsulating medium is selected from the group consisting of a fat or wax or mixtures thereof.

13. A food or beverage product comprising the colourant composition as defined in claim 1 and an edible substrate.

14. The food or beverage product according to claim 13 that is a meat analogue product, a meat analogue product comprising cultivated meat cells, or a hybrid product comprising a plant based meat analogue and cultivated meat cells.

15. The food or beverage product according to claim 13, wherein the colour of the product is red or pink when storage under cooling conditions of at less than 10° C. for at least 3 days.

16. A method of incorporating a colourant composition as defined in claim 1 into a food or beverage product, the method comprising the step of the simultaneous, separate or sequential addition of the pigment and the encapsulated one or more of: the alkali material, the acid material, the salt, and the metallic cation to said product.

17. A method of effecting a colour change in a food or beverage product as defined in claim 13, the method comprising the step of a) simultaneously, separately or sequentially adding the pigment and the encapsulated one or more of: the alkali material, the acid material, the salt, and the metallic cation to the edible base, and b) submitting the food or beverage obtained in step a) to an energetic process to release the alkali material, acid material, metallic cation and/or salt.

18. (canceled)

19. The method according to claim 17, wherein the color change in the food or beverage product results from the degradation or alternation of the pigment by the one or more of: the alkali material, the acid material, the salt, and the metallic cation after the energetic process.

20. The method according to claim 17, wherein the colourant composition comprises a pigment selected from the group consisting of phycoerythrobilins, anthocyanins, betalains, caramels, caramelized fruit and vegetables juices, burnt sugars, caramel colors, carotenoids, malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, santalin, santalin complexed with metal, or mixtures thereof, the edible base comprises plant/vegetable proteins, and comprises the encapsulated alkali material, wherein the alkali material comprises sodium bicarbonate, and the ΔE after the energetic process is of at least 2.

21. The method according to claim 17, wherein the colourant composition comprises a betanin, Vulgaxanthin, phycoerythrin and/or anthocyanin, the edible base comprises plant/vegetable proteins, and comprises the encapsulated alkali material, wherein the alkali material comprises sodium bicarbonate, and the ΔE after the energetic process is of at least 4.

22. The method according to claim 17, wherein the alkali material is encapsulated by one or more of granulation techniques, spray congealing, melt emulsification, inclusion.

23. The method according to claim 17, wherein the colourant composition or the edible base further comprises one or more additional pigment materials selected from the group consisting of caramels, caramelized fruit and vegetables juices, burnt sugars, caramel colors, carotenoids, malt, sorghum, fruit juice extracts, iron oxide colors, chlorophylls, metal substituted chlorophylls, chlorophyllin, metal substituted chlorophyllins, azaphilones, melanin, indigodine, monascin, anthraquinones, or mixtures thereof.
